(19) United States
(12) Patent Application Publication
(10) Pub. No.: US 2014/0203953 A1
(43) Pub. Date: Jul. 24, 2014

(54) TABLET COMPUTER WITH INTEGRATED TACTILE KEYBOARD

(71) Applicants: George Moser, Redwood City, CA (US); Randy Linn, Charlotte, MI (US)

(72) Inventors: George Moser, Redwood City, CA (US); Randy Linn, Charlotte, MI (US)

(21) Appl. No.: 14/027,251

(22) Filed: Sep. 16, 2013

Related U.S. Application Data
(60) Provisional application No. 61/754,847, filed on Jan. 21, 2013.

(51) Int. Cl. G06F 3/02

(52) U.S. Cl. CPC G06F 3/0202
USPC 341/27

(57) ABSTRACT

A mobile electronic device such as a tablet computer is provided having flexible display panel that deforms in response to the application of pressure thereto. The tactile response of the display panel is affected by underlying structures. A bottom layer, which may be rigid, is positioned beneath, parallel to and spaced away from the flexible display panel. Elastic diaphragms or elastic bodies can be interposed between the display panel and bottom layer. A guidance matrix, which may be rigid, can be further interposed between the display panel and bottom layer, such that pressure applied to the display panel results in localized downward deformation in the area of a guidance matrix cavity. The elastic diaphragms or elastic bodies may extend into the guidance matrix cavities. These subsurface structures may be utilized to provide variable tactile response corresponding to the locations of keys on a virtual keyboard displayed on the display panel.

### CROSS-REFERENCE TO RELATED APPLICATIONS

This application is a nonprovisional of U.S. provisional patent application No. 61/754,847, filed on Jan. 21, 2013.

### BACKGROUND

The present disclosure relates in general to the computer field, and in particular, to an improved tablet computer.

Tablet computers have grown in popularity because of their portability and the great convenience they provide. However, some shortcomings and obstacles remain which can be addressed and resolved in simple, cost-effective ways.

As shown in FIG. 1, a typical prior art tablet computer includes a housing 11 and a touchscreen 12 which is used for user input. Inside the housing 11 and underneath the touchscreen 12 there are the internal components of the computer (not shown in FIG. 1), such as the motherboard, the data storage device, the battery and others. The connector 13 is typically used to recharge the computer's battery and/or to interface with other devices. The tablet computer of FIG. 1 is shown in portrait position. FIG. 2 shows the same tablet computer of FIG. 1 in landscape position. FIG. 3 shows a cross-section of the tablet computer of FIG. 1.

One shortcoming of tablet computers is limited text input capability. For typical prior art tablets, text input is primarily based on typing on the image of a keyboard displayed on the touchscreen. This approach does not provide tactile feedback to the user and is therefore very slow, unreliable, error-prone and downright irritating to many users. It is sufficiently slow and inaccurate that many consider it viable for only very small amounts of text, such as a brief email. Creating a document can be a daunting task on a conventional touchscreen. Touchscreens work well when the user input is limited to selecting an option by clicking on a touchbutton. Input more sophisticated than that can create a problem, an inconvenience and/or reduced productivity for the user. Therefore, many tablets are considered to have a limited field of application and are not considered viable for many computer tasks.

There have been some attempts to improve input for touchscreens. Haptic keyboards generate a sound or a vibration that provides some feedback to the user. Some users may consider haptic keyboard to provide a small marginal improvement, but not to correct the problem because they fall short of providing tactile feedback correlated to the location pressed by the user.

One representative prior art disclosure is U.S. Patent Application Publication 20080211698 by Zach, which describes a keyboard with variable markings and layouts. The keyboard is made of a touch-sensitive screen, which is made of either a CRT or an LCD. The LCD may be either rigid or flexible (foldable) construction. The keyboard contains a chip that displays images on the keyboard screen. These images are the letters, characters, numbers, signs, etc. as needed. This publication does not address the issue of tactile feedback. It also does not address the issue of the structures needed under the surface of the touchscreen to provide a viable keyboard.

U.S. Patent Application Publication 20080316180 by Carmody et al. describes a flexible display covering a set of collapsible domes and physical keys formed from a sheet of rubber or flexible plastic and located under the display. A virtual keyboard shown on the flexible display informs the user where to press the display. When the user pushes the display, the display yields and compresses the key/dome. The collapse of the dome provides a tactile feedback to the user. However, one disadvantage of the mechanism described in this publication is that a set of physical keys and domes under the surface of a device like a tablet may add undesirable amounts of thickness to the device. Enormous efforts and cost go into reducing the thickness of these devices, and inserting a relatively bulky structure like physical keys and domes may not be practical or desirable for many applications. Furthermore, the structure described in this publication supports only the mechanical keys described in it, and no support is provided for the functionality of a full touchscreen such as gesturing, which has become essential in typical modern electronic devices. Finally, no method or structure is provided to prevent triggering the wrong key or triggering more than one key at a time.

U.S. Pat. No. 7,113,177 by Franzen proposes a touch-sensitive screen with three layers, including a flexible display layer, a receptor layer that detects a contact with the first layer, and an actuator layer with piezoelectrically operated knobs and pins that can modify the top layer to provide tactile feedback to the user. The described system is of significant complexity, which may present disadvantages in its reliability and affordability. Also, the minute displacements provided by the disclosed actuator are unlikely to provide highly perceptible and useful tactile feedback to the user.

Therefore, there remains a great need for a tablet computer with an effective and practical tactile feedback system that enables fast and accurate typing. Embodiments disclosed herein can be employed to provide such a solution.

### BRIEF SUMMARY

The present disclosure includes several embodiments of mobile electronic devices, such as tablets or smartphones, which are capable of providing tactile feedback to a user in response to the application of pressure by the user to at least a portion of the device's display. The tactile feedback feature can be used in connection with the implementation of a software-defined keyboard (i.e. a virtual keyboard).

An embodiment of a tablet computer is described, which is capable of providing tactile feedback to a user in response to the application of pressure by the user to at least a portion of the tablet computer display. The tactile feedback feature can be used in connection with the implementation of a software-defined keyboard. The tablet includes a housing, and a display assembly within a top surface of the housing. The display assembly includes a flexible display panel. A guidance matrix underlies the display assembly. The guidance matrix includes multiple cavities beneath the display panel, typically arranged in rows and columns consistent with a keyboard layout. The display panel can be used to display key symbol images above each cavity in the guidance matrix. When a user attempts to press a key on the keyboard image by applying pressure to a portion of the display overlying a guidance matrix cavity, the display panel deforms downwards, thereby providing the user with tactile feedback indicative of the keystroke. The display assembly may include a touch screen film overlying the flexible display panel, thereby enabling the implementation of one or multiple finger strokes, and other gestures common to usage of tablet computers, in addition to keyboard key presses.

In some embodiments, the guidance matrix is formed as a grid of guidance matrix walls to define an arrangement of cavities in rows and columns. The cavities may assume a variety of shapes. For example, the guidance matrix may be comprised of straight walls, such that its cavities are square or rectangular in cross-section and quadrilaterally-faced hexahedra in shape. In other embodiments, the guidance matrix may be formed from a solid layer or sheet of material with cavities formed in it having simple convex-shaped cross-sections, such as circles, ovals or elongated ovals. Key assemblies can be provided within the guidance matrix cavities. In one exemplary embodiment, the key assemblies each include a key cap having a top surface that is proximate to and substantially parallel with a portion of the display assembly, as well as a lateral wall extending downwards from the key cap top surface, near the periphery of the guidance matrix cavity.

The tablet computer may also include a switch assembly. One exemplary switch assembly includes a flexible first layer underlying the guidance matrix, which has switch contacts positioned on the first layer beneath the key cap lateral wall. A second insulating layer is provided beneath the first layer. The second layer has cavities positioned beneath the first layer switch contacts. A third layer lies beneath the second layer, and includes additional contacts positioned beneath the first layer contacts and second layer cavities. When the key cap is pressed downwards, the key cap lateral wall can act to deform the first layer downwards and collapse a first layer contact against a third layer contact to indicate a key press.

In other embodiments, switch assemblies can be formed from microswitches. The microswitches can be positioned between a flexible display assembly and an underlying substrate, such as a PCB. The microswitch may include tactile feedback in connection with actuation of the switch, such as a clicking action. Optionally, the microswitches may be contained within guidance matrix cavities to further define a tactile surface of the flexible display panel. Optionally, a plunger or key cap may also be interposed between each microswitch and the flexible display assembly.

In some embodiments, additional tactile feedback to a user can be implemented by including an elastic element to provide additional key resistance and restorative force. A support layer is provided beneath the guidance matrix. An elastic element can be positioned between the key cap top surface and the support layer, such that the elastic element undergoes compressive deformation in response to the application of downward force to the key cap. The elastic element can be made from elastic materials, examples of which include foam, rubber, or foam rubber.

In another embodiment, the key cap lateral wall includes a first section extending perpendicularly downwards from the key cap top surface, along the periphery of a guidance matrix cavity. A second lateral wall section extends laterally towards the center of the key cap, and a third lateral wall section continues extending downwards. This key cap structure provides a gap, at least partially beneath the key cap top surface, between the lateral wall third section and the periphery of the guidance matrix cavity. An elastic element, such as a foam ring, can be positioned within this gap. The elastic element then undergoes compressive deformation in response to the application of downward force on a key cap, and provides restorative force upon release of the downward force on the key cap. Optionally, the key cap can be configured such that the elastic element maintains the key cap in an elevated position above the support layer below when not compressed; electrical contacts can then be provided on both the key cap and the support layer below, such that connection of the contacts is indicative of a key press. The key cap itself can also be conductive, such that it can operate to connect two electrical contacts on the support layer when pressed downwards to compress the elastic element.

The guidance matrix structure described above can be provided below two separate portions of the display to implement, for example, separate keyboard areas depending on whether the tablet is used in a landscape or portrait orientation. Two separate guidance matrix structures can be used, or a single unitary guidance matrix underlying multiple areas of the display can be provided. In other embodiments, a guidance matrix can provide an array of tactile feedback areas across the entirety of a flexible display screen.

Other embodiments may include one or more buttons positioned beneath a flexible display screen, and above a switch assembly, such that downward pressure on a portion of the display screen overlying a button will cause the button to transmit the downward pressure to the underlying switch assembly. The buttons may optionally be formed from a compressible elastic material to provide further degrees of tactile feedback. The buttons may also be contained within guidance matrix cavities.

In other embodiments, a tablet computer is provided having a first display assembly within a housing top surface, which includes a touch sensitive layer and a first display screen. A second display assembly includes a second display screen. Key assemblies overly the second display assembly. Each key assembly includes a key cap having a top portion. The central area of each key cap top is substantially transparent, such that key symbols displayed on the second display screen below the key cap will be visible to a user of the device. The key caps also include a stem extending downwards from a peripheral area of the key cap top portion. An elastic layer forms a collapsible dome beneath the key cap. The collapsible dome includes a top cup adapted to engage physically with the key cap stem. A cavity in the center of the collapsible dome provides visibility to the second display screen below. The second display screen can be implemented using any of a variety of display technologies, although an electronic ink display may be preferred in some applications due to its low power consumption and easy visibility, particularly in bright conditions. The collapsible dome may include a hollow stem extending downwards which is capable of closing a three layer switch assembly to indicate depression of a key.

In accordance with another aspect, a tablet computer is provided which includes a first display assembly with a touch sensitive layer and a display screen. The tablet also includes a keyboard made from multiple key assemblies. Each key assembly includes a key cap, and a key display panel mounted on the top surface of each key cap. The key display panels are connect to a controller to cause them to display symbols associated with each key. The displayed symbols can vary based on a number of factors, such as the state of tablet operation or the language that the tablet is configured to display. Preferably, the key display panels are small electronic ink displays.

In accordance with other embodiments, key structures can be provided above a display panel. The key structures may include a key cap having a top surface with at least a center portion that is substantially transparent, enabling visibility to the display panel below, as well as peripheral walls extending downwards from the top surface. A coil spring is contained within the peripheral walls, positioned to apply elastic upwards force on the key cap to bias it upwards, while maintaining a center cavity to further allow transmission of light between the display panel and key cap central area. An electric switch mechanism can be implemented to indicate actuation of a key, such as a collapsible three layer switch or contacts between the key cap and an underlying layer. Alternatively, the key cap can be biased upwards by an elastic element circumscribing the key cap peripheral wall rather than a coil spring.

In embodiments having key at least partially transparent key assemblies positioned above a keyboard display panel, it may be desirable in some embodiments to provide a substantially flat and uniform top surface to the tablet over both the keyboard portions as well as the primary display (with the primary display typically includes a touch sensitive layer). This can be achieved by, for example, providing a top surface that is proximate and substantially parallel to (a) the primary display panel; and (b) the top surfaces of the key caps. The top surface can include a flexible or elastic material that is substantially transparent to enable users to press downwards on the key caps.

In yet other embodiments, a keyboard with tactile response can be implemented using an optical mechanism for detection of key actuation. The tablet may include a flexible top surface. A substantially transparent guidance matrix is provided beneath the flexible top surface. The guidance matrix includes an array of cavities arranged in one or more rows and one or more columns. Light guns are arranged at one end of each row and columns, oriented to emit light along the length of the row or column, at an elevation just below the flexible top surface. Light sensors are provided at the opposite end of each row and column, oriented to receive light from the light guns. Application of force by a user to the flexible top surface at a location above a guidance matrix cavity can cause downward deformation of the flexible top surface, thereby interrupting the receipt of light by the light sensors corresponding to the row and column at which downward force was applied. A controller connected to receive signals from the light sensors can process those signals to identify a key location that was pressed by a user. A display panel positioned beneath the guidance matrix can display varying key symbols associated with depression of the top surface above each guidance matrix cavity. Alternatively, the flexible top surface may include a flexible display panel, such that key symbols are displayed thereon.

Other preferred embodiments include structures imposed beneath a flexible display panel to impact the tactile response of the display panel to pressure. A mobile computing device includes a flexible display panel. A bottom layer, which may be rigid, is provided generally parallel with, separated from and underlying at least a portion of the flexible display panel. One or more elastic structures, such as elastic diaphragms or elastic bodies, are interposed between the flexible display panel and bottom layer.

Elastic diaphragms may include a first portion extending towards the bottom layer, and a second portion extending towards the display panel. The elastic diaphragms may be formed in the shape of convex domes, optionally with circumferential folds, extending between the display panel and bottom layer. The diaphragms may be integrally formed from a continuous tactile layer located between the display panel and bottom layer. Opposed electrical contacts can be provided on the diaphragm and below, such that downward deformation of the diaphragm can cause the opposed contacts to connect, thereby actuating a switch indicative of the deformation. A further insulating layer can be provided between the tactile layer and bottom layer, with the insulating layer having cavities proximate the opposed electrical contacts. In other embodiments, the opposed electrical contacts can be provided within a three layer switch structure beneath the tactile layer.

In some embodiments, a touch sensitive layer can be provided adjacent to the flexible display screen, such as on top of the flexible display screen. The mobile computing device may utilize the touch sensitive layer, the switch actuation, or both, in order to identify the location of downward pressure applied by a user to the display panel. In some embodiments, it may be desirable to expressly omit such a touch sensitive layer, thereby preventing the touch sensitive layer from obscuring display panel images, and relying on actuation of underlying switches to indication location of user contact on the display panel.

Elastic bodies can also be interposed between a flexible display panel and bottom layer, to provide resistive force in response to the application of downward pressure on a portion of the flexible display panel proximate thereto. The elastic bodies may include central cavities, in which electrical contacts on the display panel and bottom layer can be positioned. Compression of an elastic body can collapse an air gap between the electrical contacts to actuate a switch, which is associated with a predetermined position on the display panel. Optionally, the elastic bodies can be barrel shaped.

In accordance with other embodiments, an electronic display is provided according to the constructions described above.

### BRIEF DESCRIPTION OF THE DRAWINGS

FIG. 1 is a top plan view of a prior art tablet computer in portrait orientation.

FIG. 2 is a top plan view of a prior art tablet computer in landscape orientation.

FIG. 3 is a cross-section of the prior art tablet of FIG. 2.

FIG. 4 is a top plan view of a tablet computer in connection with one embodiment.

FIG. 5 is a cross sectional view of the tablet computer of FIG. 4.

FIG. 6 is a top plan view of another embodiment of a tablet computer, having a different keyboard configuration.

FIG. 7 is a cross sectional view of the tablet of FIG. 6.

FIG. 8 is a top plan view of another embodiment of a tablet computer, having a different keyboard configuration.

FIG. 9 is a cross sectional view of the tablet of FIG. 8.

FIG. 10 is a top plan view of another embodiment of a tablet computer, having a different keyboard configuration.

FIG. 11 is a cross sectional view of the tablet of FIG. 8.

FIG. 12 is a keyboard layout with a primary association between keys and symbols.

FIG. 13 is the keyboard layout with a second association between keys and symbols.

FIG. 14 is a cross sectional view of a prior art key assembly in a non-actuated position.

FIG. 15 is a cross sectional view of a prior art key assembly in an actuated position.

FIG. 16 is a cross sectional view of one embodiment of a key assembly with underlying display panel. FIG. 16A is a top plan view of the key assembly of FIG. 16.

FIG. 17 is a cross sectional view of the key assembly of FIG. 16 in an actuated position.

FIG. 18 is a cross sectional view of an embodiment of a key assembly having a key cap display panel.

FIG. 19 is a cross sectional view of another key assembly with underlying display panel.

FIG. 20 is a top plan view of the key assembly of FIG. 19.

FIG. 21 is a top view of a tablet computer employing a keyboard with reduced row count.

FIG. 22 is a cross section of another key assembly embodiment with underlying display panel.

FIG. 23 is a cross section of the key assembly of FIG. 22 in an actuated position.

FIG. 24 is a top plan view of a guidance matrix.

FIG. 25 is a cross section X-X of the guidance matrix of FIG. 24.

FIG. 26 is a cross section of another key assembly embodiment having an underlying display panel and continuous top surface.

FIG. 27 is a top plan view of the key assembly of FIG. 26.

FIG. 28 is a cross section of the key assembly of FIG. 27 in an actuated position.

FIG. 29 is a cross section of another key assembly embodiment having an underlying display panel and continuous top surface.

FIG. 30 is a cross section of another key assembly embodiment having an underlying display panel and continuous top surface.

FIG. 31 is a top plan view of the key assembly of FIG. 30.

FIG. 32 is a cross-section of another embodiment of a sub surface keyboard assembly.

FIG. 33 illustrates the assembly of FIG. 32 with a key in an actuated position.

FIG. 34 is a schematic diagram of the keyboard assembly of FIG. 32.

FIG. 35 is a schematic diagram of the keyboard assembly of FIG. 33.

FIG. 36 is a cross section of another sub surface keyboard assembly.

FIG. 37 is a top plan view of a matrix structure from the assembly of FIG. 36.

FIG. 38 is a cross section of another sub surface keyboard assembly.

FIGS. 39 and 40 are top plan views of matrix structures from the assembly of FIG. 38.

FIG. 41 is a cross section of another sub surface key assembly with underlying display panel.

FIG. 42 is a cross section of the assembly of FIG. 41 in an actuated position.

FIG. 43 is a cross section of another sub surface key assembly with underlying display panel.

FIG. 44 is a top view of a tablet computer with sub surface keyboard in accordance with another embodiment.

FIG. 45 is a top view of the tablet of FIG. 44 during video media consumption.

FIG. 46 is a top view of the tablet of FIG. 44 during text entry.

FIG. 47 is a top view of a tablet computer with sub surface keyboard structure. FIG. 47A is a cross section X-X of the tablet of FIG. 47. FIG. 47B is an enlarged partial cross-section X-X of the tablet of FIG. 47.

FIG. 48 is a perspective view of an embodiment of a guidance matrix.

FIG. 49 is a top view of the guidance matrix of FIG. 48.

FIG. 50 is a perspective view of another embodiment of a guidance matrix.

FIG. 51 is a top view of the guidance matrix of FIG. 50.

FIG. 52 is a cross section of a key assembly implemented beneath a flexible display assembly. FIG. 52A is a top plan view of the key assembly of

FIG. 52.

FIG. 53 shows the assembly of FIG. 52 in an actuated position.

FIG. 53A is a cross section of another embodiment of a key assembly with a button structure implemented between a flexible display assembly and underlying switch.

FIG. 53B is a cross section of yet another embodiment of a key assembly implemented beneath a flexible display assembly.

FIG. 54 is a cross section of another variation of a key assembly implemented beneath a flexible display panel.

FIG. 55 illustrates the key assembly of FIG. 54 in an actuated position.

FIG. 56 is a cross section of another embodiment of a key assembly implemented beneath a flexible display panel.

FIG. 57 is a cross section of another embodiment of a key assembly implemented beneath a flexible display panel.

FIG. 57A is a cross section of another embodiment of a key assembly having microswitches implemented beneath a flexible display panel.

FIG. 57B is a cross section of another embodiment of a key assembly with microswitches and a guidance matrix implemented beneath a flexible display panel.

FIG. 58 is a top view of a tablet computer having sub surface keyboard assemblies for use during either landscape or portrait orientations.

FIG. 59 is a top view of another embodiment of a tablet computer having a sub surface keyboard assembly for use during either landscape or portrait orientations.

FIG. 60 is a top view of another embodiment of a tablet computer, having a tactile input mechanism implemented beneath substantially all of the tablet display.

FIG. 61 is a cross-section of a mobile device key structure with sub-surface electrical contacts.

FIG. 62 is a top plan view of the key structure of FIG. 61.

FIG. 63 is a cross-section of the key structure of FIG. 61 when in a compressed state.

FIG. 64 is a cross-section of a further embodiment of a mobile device key structure with subsurface electrical contacts.

FIG. 65 is a cross-section of a further embodiment of a mobile device key structure with subsurface electrical contacts.

FIG. 66 is a cross-section of the key structure of FIG. 65 when in a compressed state.

FIG. 67 is a perspective view of a subsurface guidance matrix.

FIG. 68 is a cross-section of a further embodiment of a mobile device key structure, with subsurface electrical contacts and a subsurface guidance matrix.

FIG. 69 is a cross-section of the key structure of FIG. 68 when in a compressed state.

FIG. 70 is a cross-section of a further embodiment of a mobile device key structure, with subsurface electrical contacts and a subsurface guidance matrix.

FIG. 71 is a cross-section of the key structure of FIG. 70 when in a compressed state.

FIG. 72 is a cross-section of a further embodiment of a mobile device key structure with a subsurface deformable structure.

FIG. 73 is a cross-section of the key structure of FIG. 72 when in a compressed state.

FIG. 74 is a cross-section of a further embodiment of a mobile device key structure with a subsurface deformable structure and subsurface guidance matrix.

FIG. 75 is a cross-section of the key structure of FIG. 74 when in a compressed state.

FIG. 76 is a cross-section of a further embodiment of a mobile device key structure with a subsurface elastic structure.

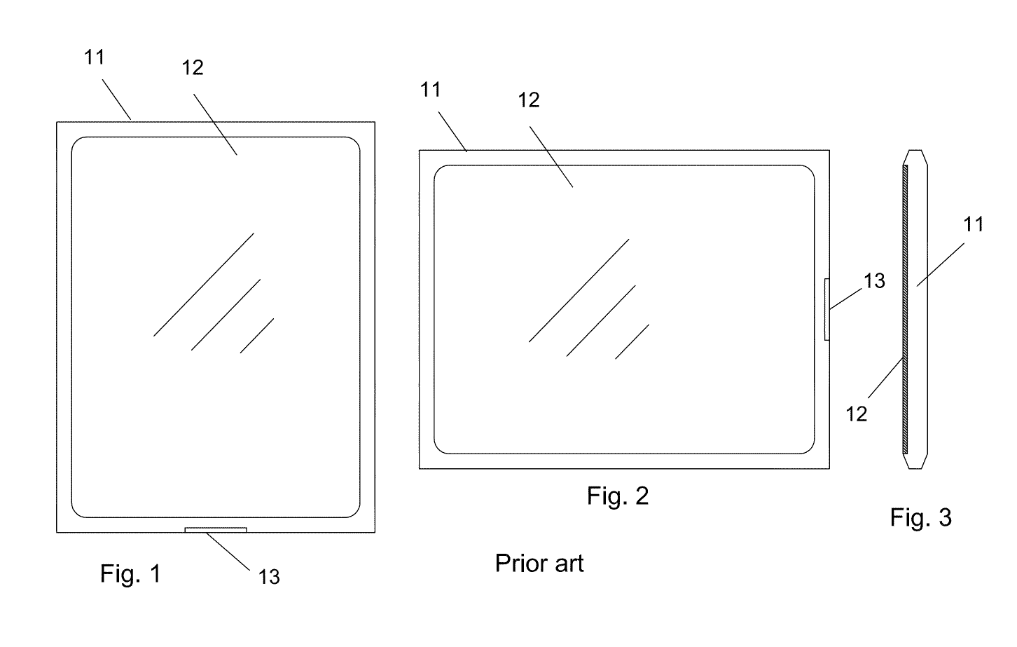

### DETAILED DESCRIPTION

While this invention is susceptible to embodiment in many different forms, there are shown in the drawings and will be described in detail herein several specific embodiments, with the understanding that the present disclosure is to be considered as an exemplification of the principles of the invention and is not intended to limit the invention to the embodiments illustrated.

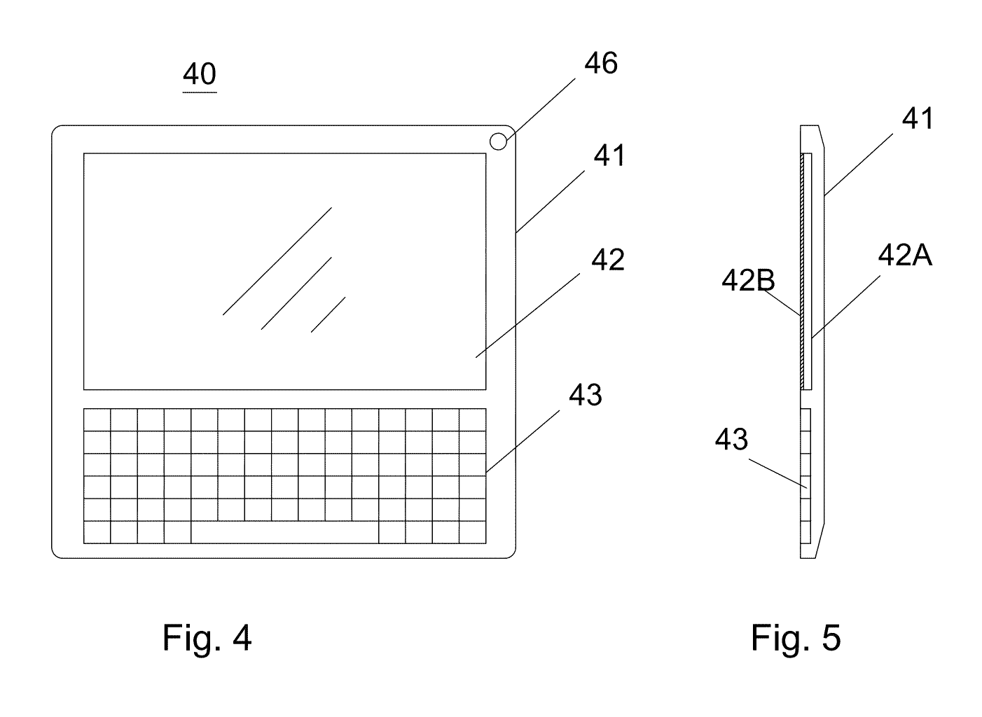

FIG. 4 shows a top plan view of a tablet computer in accordance with a first embodiment. The tablet computer 40 includes a housing 41 and a touchscreen 42. The touchscreen 42 generally consists of an LCD panel 42A with an overlay film 42B (FIG. 5) on top of it, which overlay film 42B is the actual touch sensitive component. The touch sensitive overlay film 42B can be based on one of a variety of touch screen technologies known in the art, such as resistive, capacitive, Saw effect based, infrared, etc. A toggle switch button 46 is used to activate or deactivate the keyboard 43, and prevent the user from inadvertently pressing a key on keyboard 43 while using the device in touchscreen mode only. FIG. 5 is a cross-section of the tablet computer in FIG. 4, showing touch sensitive overlay 42B, LCD panel 42A, housing 41 and keyboard 43. This tablet has been equipped with a physical keyboard 43 (as opposed to a virtual keyboard displayed on touchscreen 42) in order to provide a fast and reliable input mechanism to the user.

The keyboard of FIG. 4 represents a trade-off, because keyboard 43 occupies some of the surface area of the tablet that otherwise would be available for a larger screen. While this tradeoff may be acceptable and desirable to many users for whom input is important, it is also desirable to preserve as much area as possible for the screen rather than using it for the keyboard. That dictates the need for a small keyboard (without making the physical size of the keys or the distance between keys too small, because then the keyboard would not be convenient any longer).

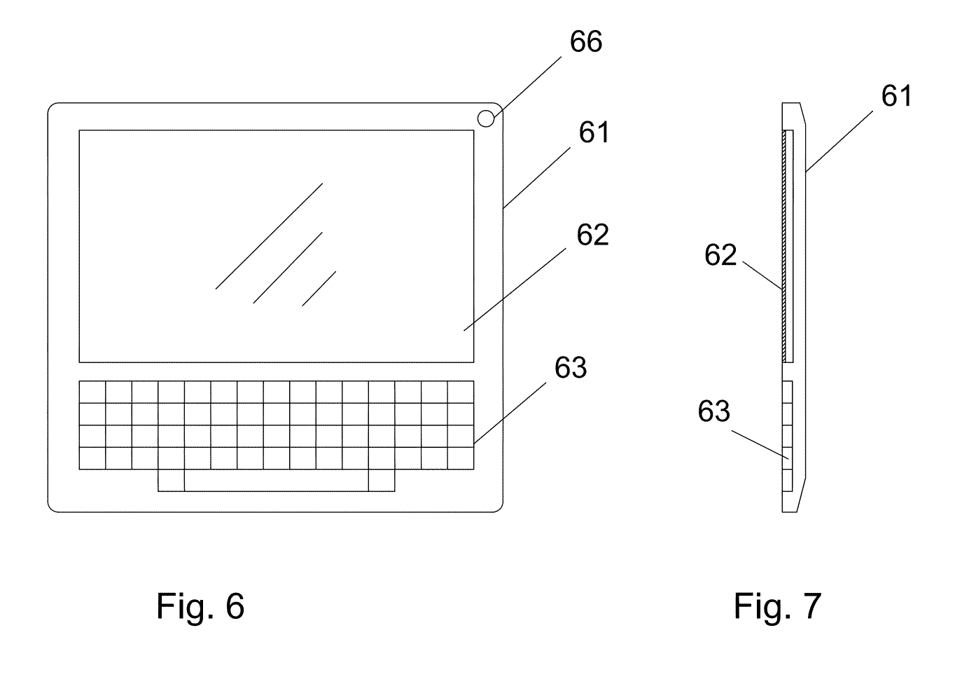

FIG. 6 shows another embodiment of a tablet with housing 61, touchscreen 62, keyboard 63 and keyboard activation toggle switch 66. Keyboard 63 includes only five rows of keys (as opposed to six rows on keyboard 43 in FIG. 4). A keyboard with five rows of keys can be achieved by assigning more than one function to at least some of the keys. FIG. 7 is a cross-section of the tablet of FIG. 6.

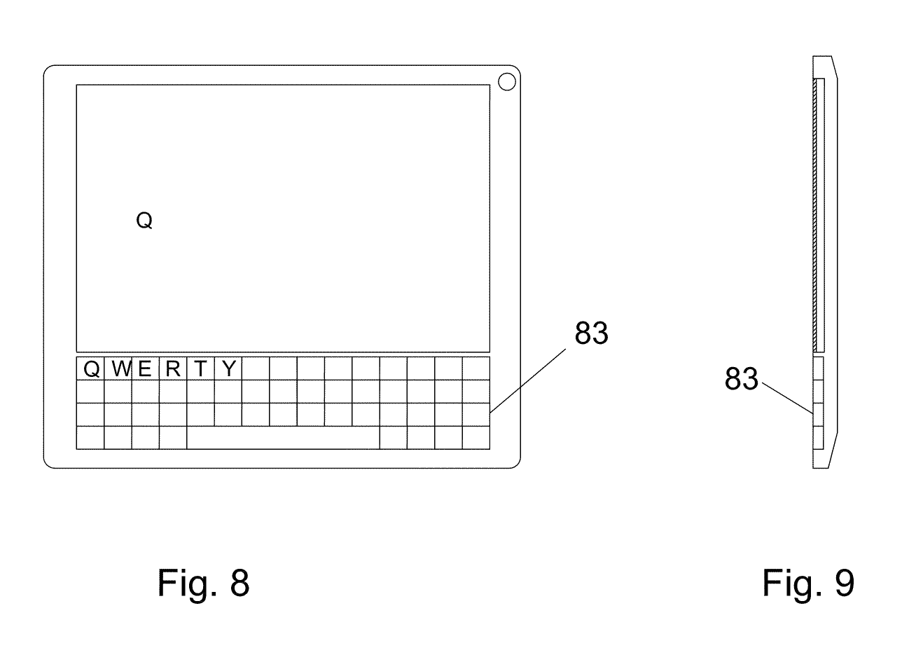

FIG. 8 shows another embodiment of a tablet having a keyboard 83 with only four rows of keys. That is the smallest number of rows that can be used while still using the conventional QWERTY key layout unmodified (which many users are used to). FIG. 9 is the cross-section of the tablet of FIG. 8.

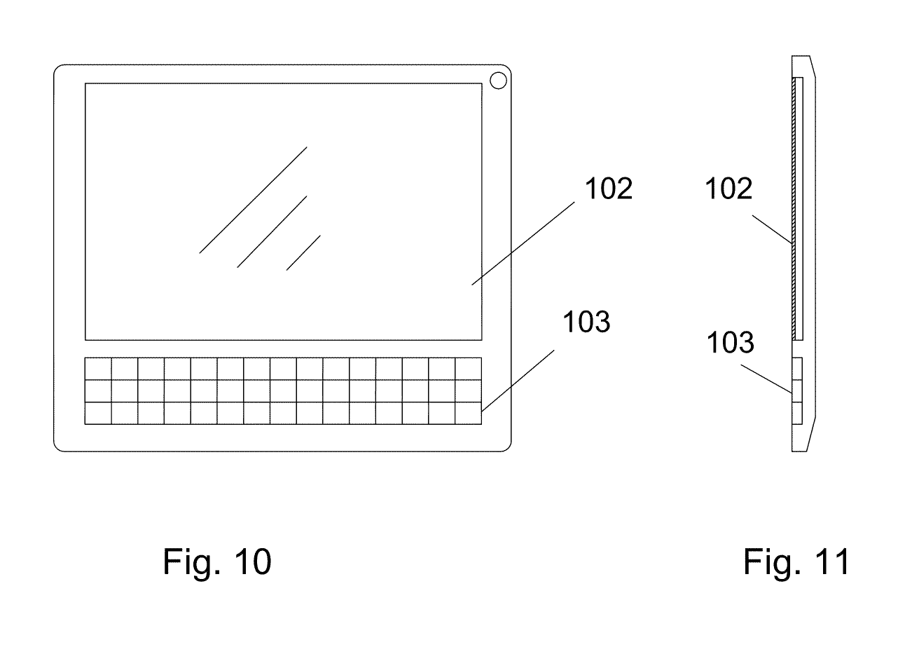

FIG. 10 shows another tablet embodiment, the embodiment including keyboard 103. Keyboard 103 includes three rows of keys, thereby further reducing the proportion of the surface area of the tablet consumed by the keyboard. Implementing keyboard 103 with three rows of keys requires some minimal deviations from the traditional QWERTY layout, which deviations may be acceptable to many users in order to maximize available surface area for display 102. FIG. 11 shows a cross-section of the tablet in FIG. 10.

In the aforementioned embodiments of FIGS. 4-11, the keyboard reduces the surface area on the top of the tablet available for the screen, which is a necessary tradeoff in those embodiments. To reduce the amount of area that has to be devoted to the keyboard, other embodiments described herein include alternative keyboard structures.

One type of alternative keyboard structure described herein includes partially transparent keys that are mounted on top of an LCD panel, so that the key labels are not printed on top of the keycaps, but instead they are displayed on the LCD panel under the keyboard in the appropriate positions beneath each key, so that the user can see the labels through the transparent portions of the keyboard keys. Since each key labels is an image on the LCD panel, it can be dynamically configured to be anything the software and/or the user may want it to be at any time.

By utilizing a partially transparent keyboard to enable visibility through to an underlying LCD display, symbols corresponding to keyboard keys can be conveyed to a user without printing multiple labels on the keys, as is typically done on conventional keyboards. Also, there is no need to have dedicated keys for less-frequently used elements such as numbers, punctuation, functions, special symbols, etc. For instance, a default keyboard layout could include just the standard QWERTY characters and a few of the most frequently used control keys (such as Enter, Del and Backspace). When the user wants to enter a number, he/she can press a key (labeled, e.g., Num for Numbers, or something similar) in response to which the keyboard would instantly switch to numeric input and numeric symbols would be displayed underneath the keyboard keys. The same mode of operation can be achieved for punctuation, special symbols, foreign keyboards, etc. Optionally, the punctuation, which is often small and difficult for users to see on standard keyboards, can now be displayed in large size using the full key top surface, avoiding the common confusions between similar punctuation symbols.

A further advantage of some embodiments described herein is that the keyboard can be configured by the software application to cooperate with the application, such as dynamically and contextually re-defining certain keys to match user input options associated with the application's present state of operation, such as YES, NO, BACK, GO ON, GO TO, STOP, CANCEL, EXIT, etc. The application can blink certain keys corresponding to expected input, or change the color of certain keys to contextually guide the user. Such a smart keyboard opens many new possibilities to the software and the application. As another side benefit, this can lead to some level of standardization in application software which can simplify the learning and usage of software applications.

Another potential benefit would be that embodiments of such a keyboard could be global in application, displaying language- and/or culture-specific characters and/or text without hardware changes, with languages used across the world, such as New York, New Delhi, Berlin, Paris, Madrid, London, Beijing, Moscow or Tokyo. Such keyboard globalization can lead to substantial cost savings and logistical simplification for computer manufacturers. Country-specific customization for computers could be primarily achieved through software, which may be easier and less expensive to implement, and in many cases may be accomplished by the user through an Internet download. The hard disk could come with the necessary keyboard drivers loaded in it, and the user could select a setting for the desired driver.

To the extent that symbols corresponding to each key are displayed on a display panel underlying the keys, it may be desirable in some embodiments to provide for variable brightness or intensity of said display panel output to accommodate different working conditions. In some embodiments, users are provided with controls for setting the brightness of a display underlying a keyboard structure to suit user preference and ambient conditions. In other embodiments, keyboard display brightness may be controlled automatically. For example, it is known in the art of portable computers to provide for detection of ambient light conditions, so that the brightness of a primary computer display can be increased in the presence of high levels of ambient light, and decreased in the presence of lower levels of ambient light, thereby maintaining comfortable working conditions. However, many prior art keyboards are either unlighted, or may provide for fixed intensity of backlighting. In an exemplary embodiment of the present invention, the detected intensity of ambient light may be used to vary the intensity of the display panel underlying various keyboard structures.

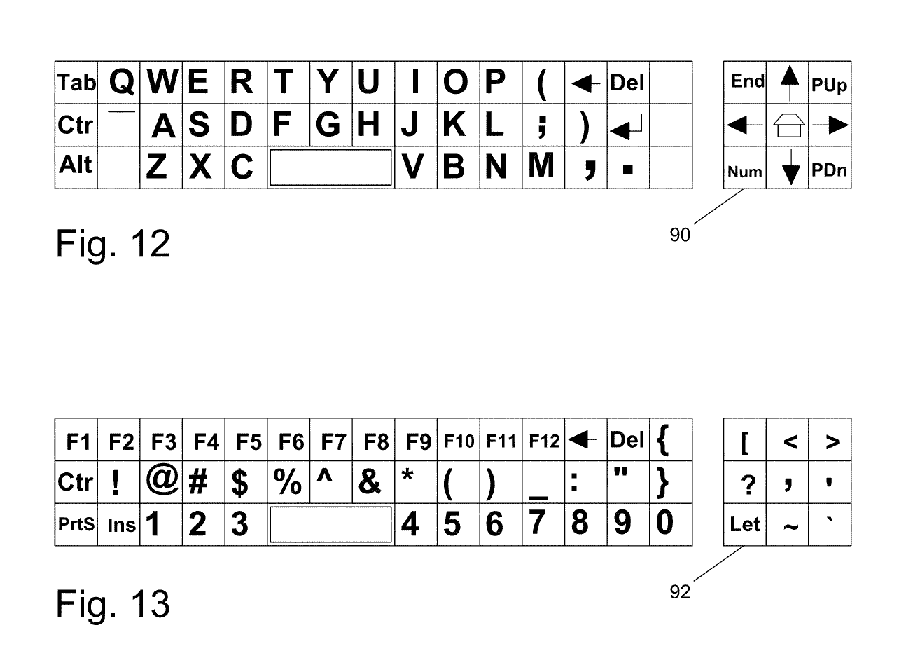

FIGS. 12 and 13 illustrate an embodiment of a smart keyboard in accordance with aspects of the present invention, which does not require dedicated keys, such that the keyboard can be made with significantly fewer physical keys than in conventional keyboards. FIG. 12 illustrates a primary set of symbols associated with each keyboard key, while FIG. 13 illustrates an alternative set of symbols that can be associated with each keyboard key. The layout of FIG. 12 requires only 3 rows of keys as opposed to the customary 6 or more rows in a conventional keyboard, while maintaining standard orientation of English-language letter keys relative to one another. If the user wants to enter a number or a special punctuation not shown in FIG. 12, selection of “Num” key symbol 90 by a user can operate to change the keyboard symbol set of that of FIG. 13. Specifically, the computer responds to depression of the “Num” key by altering a display underlying the partially-transparent keypad to illustrate the symbols on FIG. 13. Similarly, when the key symbol set of FIG. 13 is displayed, operation of the “Let” key symbol 92 by a user can operate to change the keyboard symbol set back to that of FIG. 12. Also, since there is no need to squeeze multiple labels on the key top, it may be possible to make each individual key area smaller without undesirably sacrificing legibility of key symbols. As a result, the total keyboard area can be made significantly smaller than conventional keyboards, without inconveniencing the user.

In some applications, user convenience can even be improved, because the label can show punctuation and other small characters in full size, making it easier to see them, even for users with some level of vision deterioration or handicap. For example, the keyboard symbol set of FIG. 12 includes a comma symbol that is proportionally larger than a traditional keyboard comma symbol, such that it utilizes most or all of the available key symbol space and is more easily distinguished by a user from other punctuation marks, such as a period or semicolon. Many people who might otherwise require eyeglasses for typing, could find themselves typing on a keyboard implementing the software-defined symbol sets of FIGS. 12 and 13 without needing glasses. Meanwhile, the software-defined symbol sets of FIGS. 12 and 13 can be implemented with keyboard structures providing tactile feedback that is the same as, or similar to, that of conventional keyboards.

Using the principles of this embodiment, it is possible to also design a layout that would have less than three rows of keys. Such a layout would differ from the traditional QWERTY layout in terms of the relative positioning and availability of letter keys, but for users who can accept that change, it would reduce the surface area required and a keyboard and provide even greater screen area for information to be displayed on the tablet display screen. Potentially, as little as one row of keys could be provided at the bottom of the base unit. This is a feature that could be very useful in tablet computers that try to maximize available screen area.

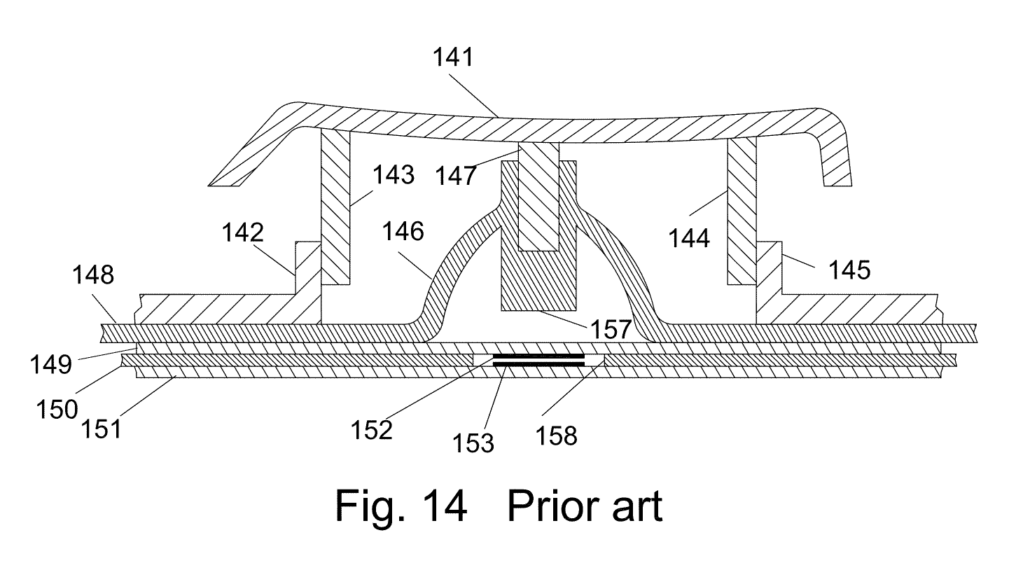

FIG. 14 shows a cross-sectional view of a key in a prior art conventional keyboard of the commonly used membrane type. The keycap 141 is supported by posts 143 and 144, which are movably supported by the walls 145 and 142. The keycap stem 147 is inserted into the flexible membrane dome 146. The membrane 148 rests on top of a 3 layer “sandwich”, which constitutes the actual electrical circuit of the keyboard:

a) layer 149 is a non-conductive film with conductive circular pad 152 printed on it;

b) layer 151 is a similar non-conductive film with conductive circular pad 153 printed on it; and

c) the intermediate layer 150 is an insulating film with circular hole 158, which is concentric with the circular pads 152 and 153.

Because of the thickness of the insulator layer 150, there is normally a small gap between the conductive pads 152 and 153, i.e. the circuit is open.

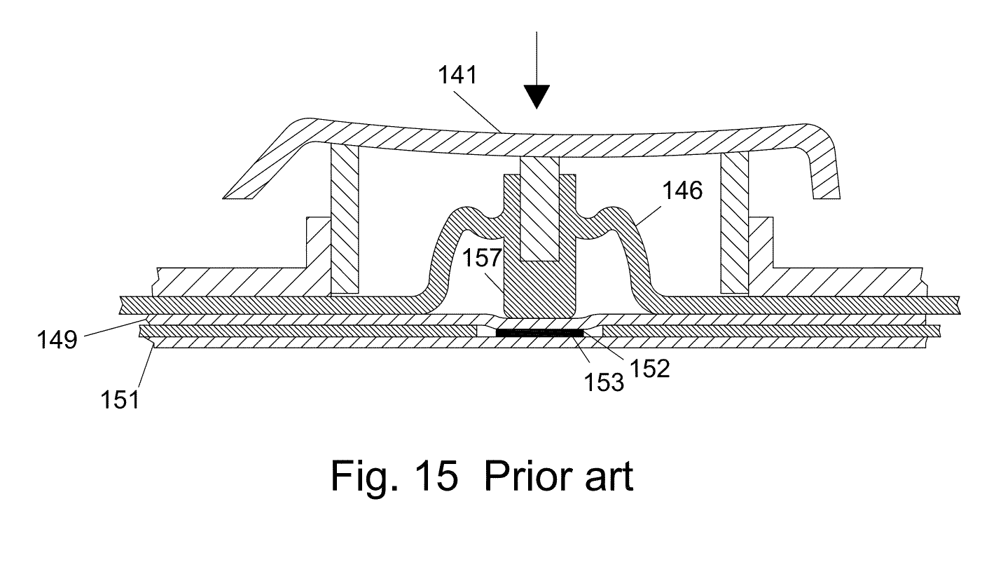

FIG. 15 shows what happens when the user depresses keycap 141. The keycap 141 descends, pushing down the dome 146 and causing it to collapse and fold as shown. The collapse of the dome, the downward stroke and the resistance of the collapsing rubber structure is what provides the tactile feedback to the user. The rubber stem 157 compresses layers 149 and 151 underneath, closing the circuit between pads 152 and 153. The keyboard microprocessor, which is connected to the layers and the conductive pads 152 and 153 by multiple conductive traces on the layers (not shown), interprets this closed circuit as the key having been actuated by the user.

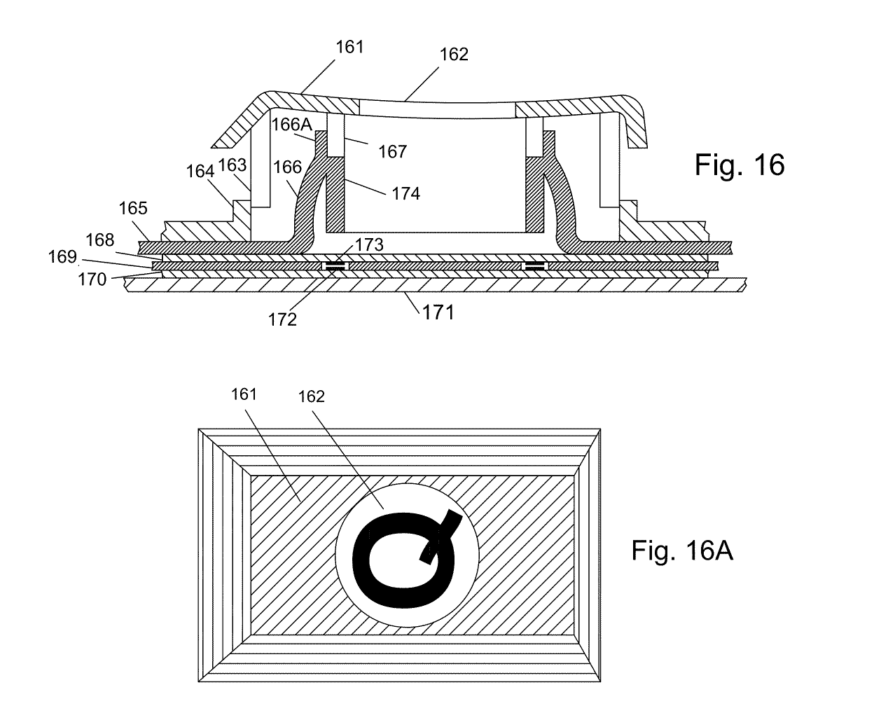

FIG. 16 shows an embodiment of a new keyboard construction. The keycap 161 is made of transparent plastic, glass or other transparent material. Central keycap portion 162 is largely transparent, so that the user can readily see through it. Shaded (cross-hatched) areas of keycap 161 are preferably painted or made of semi-translucent material such as smoked glass, to reduce the extent to which the user also sees the internal mechanisms of the keyboard. The stem 167 of keycap 161 is inserted into the top cup 166A of the membrane dome 166. The inner diameter of top cup 166A generally matches the outer diameter of stem 167. The dome also has an internal hollow cylindrical stem 174, which can be pushed down by stem 167 of keycap 161 to compress layers 168, 169 and 170. The conductive pads 172 (attached to layer 170) and 173 (attached to layer 168) are normally open, with a small gap between them. Layers 168, 169 and 170 are fully or partially transparent (except possibly on the conductive pads 172 and 173 and/or conductive traces), thereby providing user visibility to at least portions of LCD display 171. LCD display 171 can be used to display a key symbol associated by a tablet computer with keycap 161. As described above, the brightness of LCD display 171 can be made to vary with detected levels of ambient light. In the illustrated embodiment, the conductive pads 172 and 173 are shaped as rings (or portions of a ring, or dots within the projected area of the cylinder) that confront the bottom of the hollow cylindrical rubber stem 174 when keycap 161 is depressed.

FIG. 16A shows a top view of a key in accordance with the embodiment of FIG. 16, showing transparent area 162 and the non-transparent area 161. The letter Q seen on the center is actually displayed on LCD 171 located underneath keycap 161 and layers 168, 169 and 170.

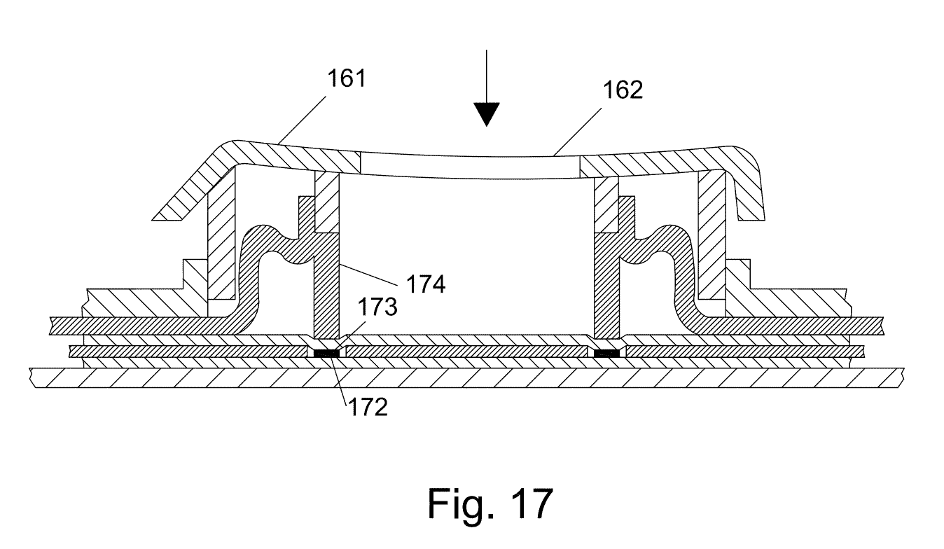

FIG. 17 shows what happens when keycap 161 is depressed. Pressure from keycap 161 on hollow cylindrical stem 174 causes the dome to collapse and compresses layers underneath, causing pads 172 and 173 to contact one another and close the circuit, which signals to the processor that the key has been actuated.

While a key assembly has been described above in connection with FIGS. 16-17, and other embodiments of key assemblies are described elsewhere herein, it is understood and contemplated that typical product implementations of tablet computers, and potentially other computer form factors, using one or more of the key assemblies described herein, will additionally include other types of keys, buttons and switches. Nothing should be deemed to mandate the use of the key assemblies described herein to the complete exclusion of other types of software or hardware-based input mechanisms.

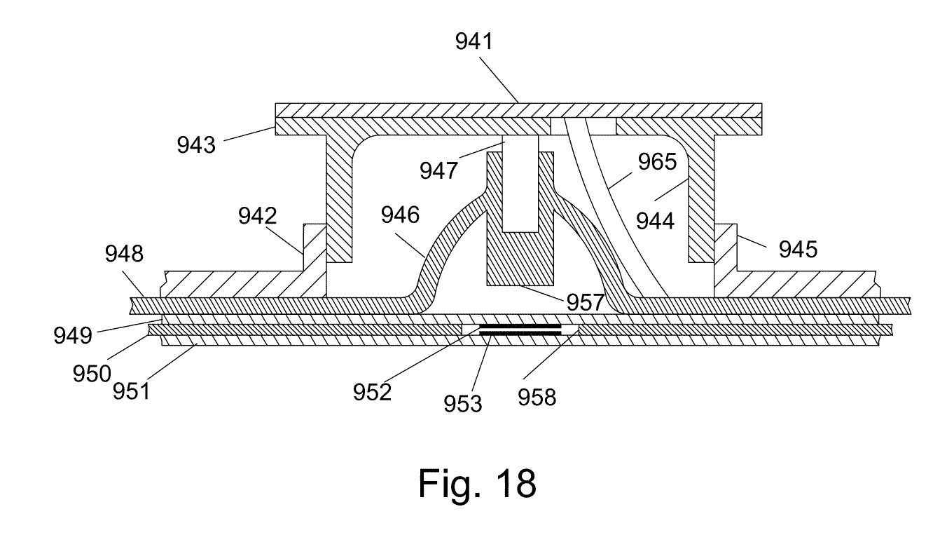

FIG. 18 shows a cross-sectional view of a representative key mechanism for a further embodiment of a computer keyboard, which can be advantageously used in the context of a tablet computer. In this embodiment, the label showing the character assigned to the key is displayed on a miniature display panel 941 attached to the top of keycap 943, and electrically connected to the tablet through cable 965. The miniature display 941 can be implemented using any of a variety of different display technologies, such as LCD, OLED, e-ink or others. Generally a preferred embodiment is an e-ink miniature display, because the low power consumption of the e-ink displays can be advantageous and the monochromatic nature of conventional e-ink displays may be considered adequate for a keyboard keycap. The keycap 943 is movably supported by walls 945 and 942. The keycap stem 947 is inserted into a receptacle formed in the flexible membrane dome 946. Membrane dome 946 is formed as part of membrane 948, which rests on top of a three layer “sandwich” constituting the actual electrical circuit and switch mechanism of the keyboard. The three layer sandwich includes a) conductive layer 949 with conductive pad 952 attached to or printed on it; b) conductive layer 951 with conductive pad 953 attached to or printed on it; and c) the intermediate insulating layer 950 with circular hole 958, which is concentric with the circular pads 952 and 953.

Because of the thickness of the insulator layer 950, there is normally a small gap between the conductive pads 952 and 953, i.e. the circuit is open. When the user pushes down the key 943, the plunger 957 compresses the three-layer sandwich and creates electric contact between pads 952 and 953, which a tablet integrated circuit (not shown) interprets as the key having been actuated.

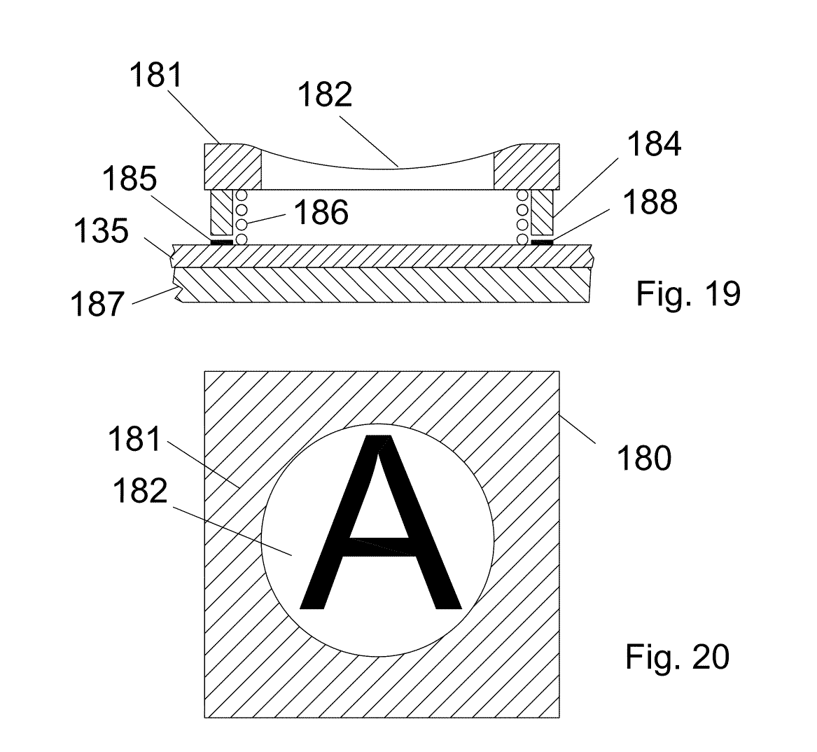

FIG. 19 shows another embodiment of the smart semi-transparent keyboard, which uses a cylindrical coil spring 186 (instead of a flexible dome) to provide resistance to depression of keycap 181, and corresponding restoring force. Keycap 181 includes cylindrical stem 184, comprised of an electrically-conductive material. The embodiment of FIG. 19 further includes transparent layer 135 positioned over LCD display panel 187. Conductive pads 185 and 188 are mounted on transparent layer 135, at positions directly beneath keycap stem 184. Thus, when keycap 181 is depressed, compressing spring 186, keycap stem 184 contacts both pads 185 and 188, thereby connecting them electrically and closing a circuit to indicate depression of keycap 181.

FIG. 20 is a top plan view of keycap 181 from the embodiment of FIG. 19. Transparent center region 182 allows a user to view a portion of LCD 187, while non-transparent portion 181 visually obscures keyboard mechanisms such as coil spring 186 and conductive pads 185 and 188. It is to be understood that, as used herein, terms such as transparent and opaque are relative terms meant to convey varying levels of visibility through a material. It is understood that description herein of materials as “transparent” is intended to convey they ability of a user to see through the material sufficiently to receive information displayed beneath the material. Thus, materials described as “transparent” may, in fact, have some level of translucency.

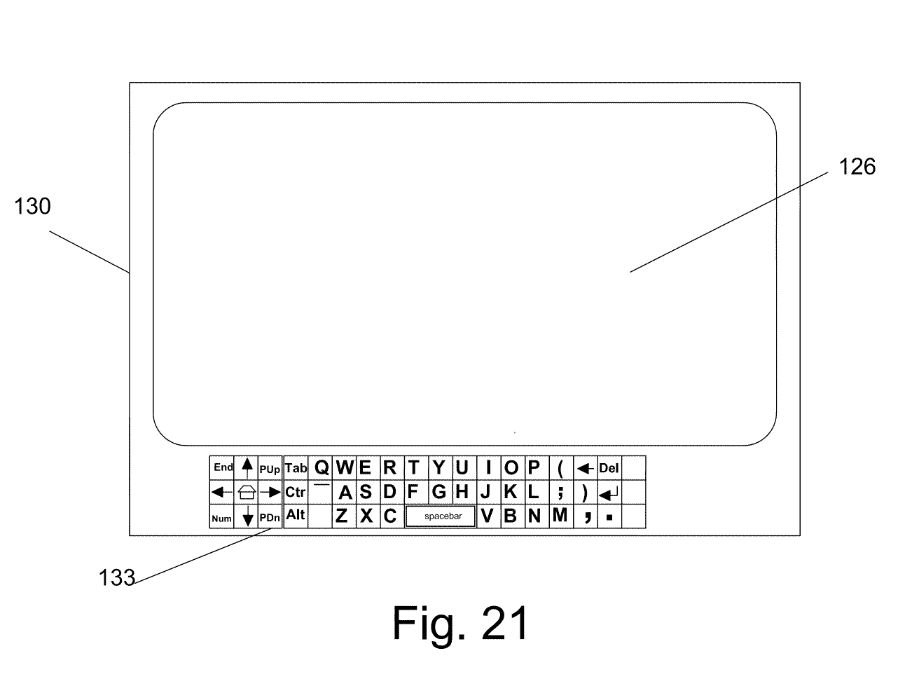

FIG. 21 illustrates an embodiment of a tablet computer with an advantageous form factor enabled by keyboard structures described herein. FIG. 21 provides a top plan view of a tablet computer 130 having display panel 126 and keyboard structure 133. Keyboard 133 provides standard full-sized keys, yet the surface area occupied by keyboard 133 is substantially less than conventional keyboards due to its implementation using just three rows of keys, thereby providing substantially more surface area for display panel 126. As described above in connection with FIGS. 12-20, the symbol or action associated with each key is indicated by an icon displayed beneath each key on a display panel, while the keys of keyboard 133 include at least portions which are relatively transparent, enabling a user to view the key symbols displayed beneath. The symbol or action associated with at least some of the keys can be changed dynamically to provide ready access to all standard characters.

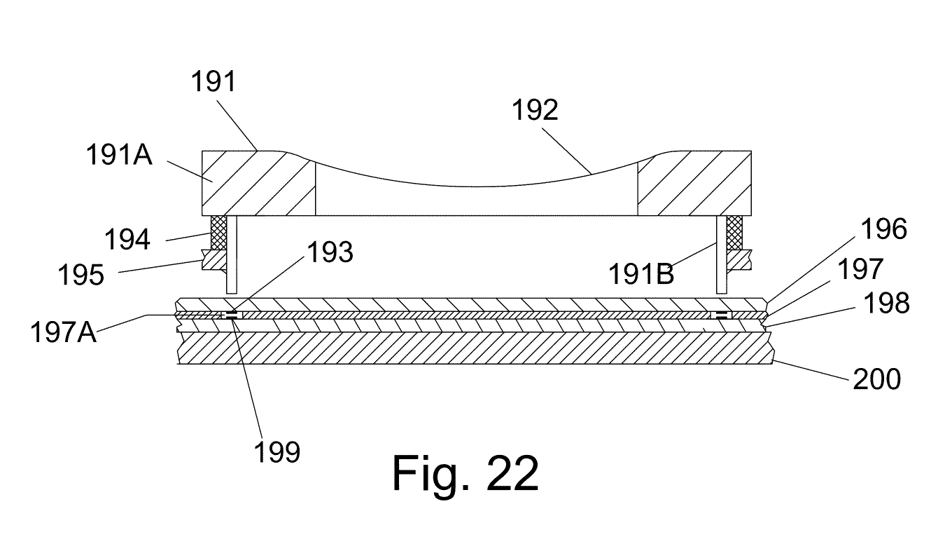

FIG. 22 shows another embodiment of a smart keyboard employing an alternative mechanism for tactile feedback and restoring force upon depression of a keycap. The embodiment of FIG. 22 continues to utilize a three-layer approach to detection of presses of keycap 191, analogous to that described above. Specifically, conductive pads 193 and 199 are attached to layers 196 and 198, respectively. Layers 196 and 198 are separated by layer 197. Layer 197 includes gap 197A, providing for a small air gap between conductive pads 193 and 199 when keycap 191 is not in a depressed position. LCD display 200 can be controlled to display an image of a key symbol associated with keycap 191 beneath keycap transparent portion 192.

Keycap 191 is comprised of top portion 191A and stem 191B. Top portion 191A includes transparent center portion 192. Stem 191B extends substantially perpendicularly downwards from the underside of top portion 191A, towards conductive pads 193 and 199. Stem 191B is surrounded by elastic compressible member 194. Supporting structural wall 195 surrounds keycap stem 191B but allows keycap 191 to move vertically relative to structural wall 195, while structural wall 195 remains in a fixed elevation relative to, e.g., layers 196, 197 and 198. Compressible member 194 is situated between the underside of keycap top portion 191A and supporting structural wall 195. It is contemplated that supporting structural wall 195 in the illustrated embodiment may form a keyboard top surface filling space between key caps in a keyboard made from multiple key assemblies. However, it is also understood that other structures could be utilized as a support element between key cap 191 and elastic member 194, particularly to the extent that the support element maintains a consistent elevation with respect to display panel 200, relative to which key cap 191 can move up and down. Compressible member 194 may be comprised of elastic materials such as rubber or foam. During a resting state, compressible member 194 holds keycap top portion 191A away from supporting structural wall 195 by a distance sufficient to prevent stem 191B from compressing layers 196 and 198, such that conductive pads 193 and 199 continue to be separated by an air gap.

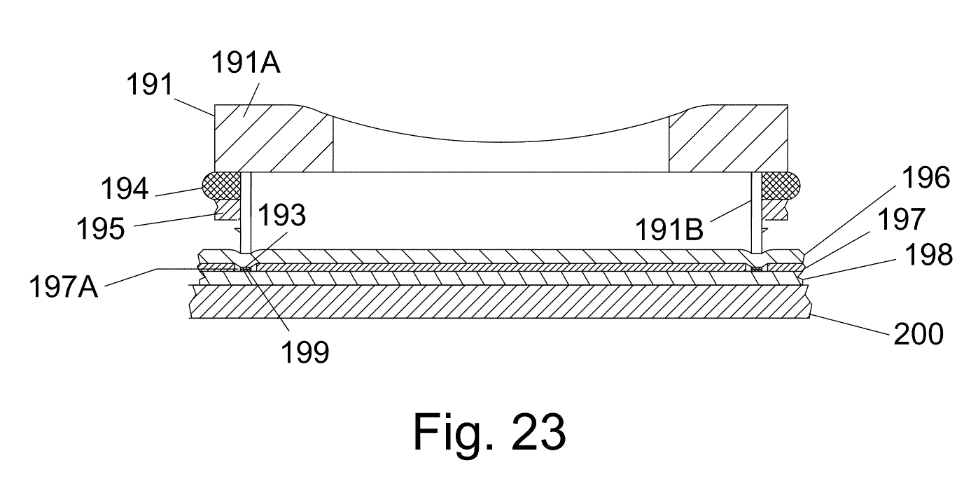

FIG. 23 shows what happens when keycap 191 is depressed. Compressible member 194 deforms as it is compressed between the underside of keycap top portion 191A and supporting structural wall 195, reducing the thickness of compressible member 194 and allowing keycap 191 to descend towards layers 196, 197 and 198. Stem 191B contacts layer 196, compressing layers 196 and 198 within gap 197A and causing conductive pads 193 and 199 to contact one another, closing the circuit.

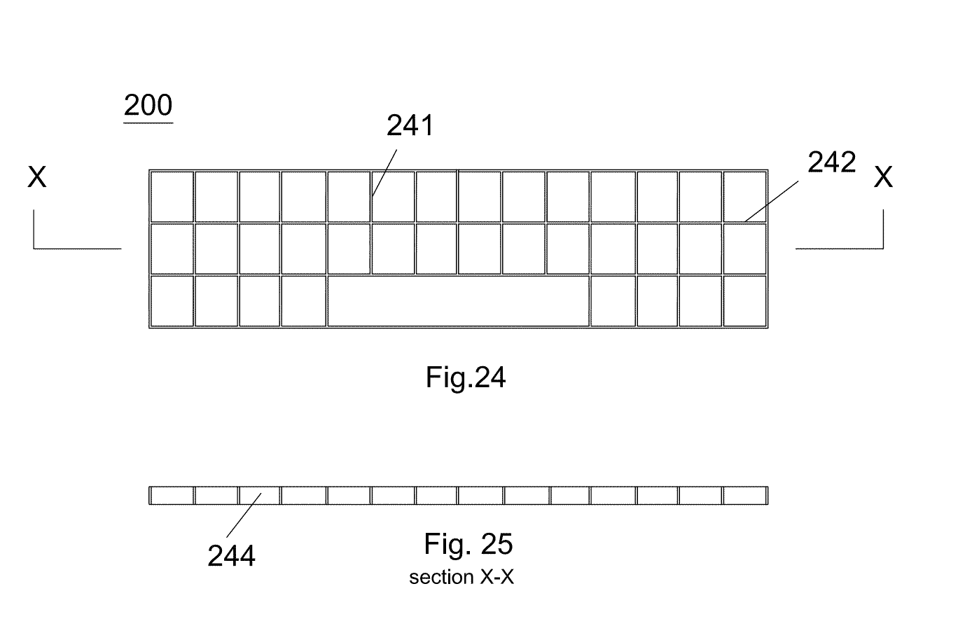

FIGS. 24-40 show different embodiments of a keyboard which can be installed beneath a continuous top surface of the tablet computer (as opposed to keys being exposed on top of the tablet as described in the previously-described embodiments). This type of keyboard will be referred to as a sub-surface keyboard. Embodiments of such a sub-surface keyboard can be employed to enable user input without requiring a touchscreen in the keyboard area, therefore enabling high typing speed, high reliability and low cost. Embodiments of the sub-surface keyboard can provide numerous potential advantages such as tactile feedback to the user and dynamically configurable keys, without some of the potential downsides of an over-the-surface mechanical keyboard, such as aesthetic concerns. Typically, a tablet computer utilizing these types of subsurface keyboards will include two display screens: a first display screen that is the primary graphical display for the device (and which will often be a touchscreen), and a second display screen which underlies the keyboard structure (and which in many embodiments need not be a display screen). While the primary display will typically be at or very near the top surface of the tablet computer, the keyboard display may be offset from the primary display, recessed from the tablet top surface, in order to provide space for the keyboard structures disclosed herein.

FIG. 24 shows a guidance matrix 200, which can be implemented to define key positions in some embodiments of a subsurface keyboard and guide the user's finger toward the right spot, providing tactile feedback while improving accuracy and reducing opportunities for inadvertent simultaneous depression of multiple keys. Guidance matrix 200 can be comprised of plastic, glass or similar material, is preferably transparent, and includes a series of walls in X-direction (such as wall 242) and a series of walls in Y-direction (such as wall 241). FIG. 25 is a cross-sectional view X-X of guidance matrix 200, with X-direction and Y-direction walls defining a series of compartments 244, each corresponding to a key position.

The guidance matrix shown in FIGS. 24 and 25 is that of a three row keyboard, but of course the principle can be generalized in other embodiments to any key configuration by alternating the quantity, position and size of compartments defined by the guidance matrix walls.

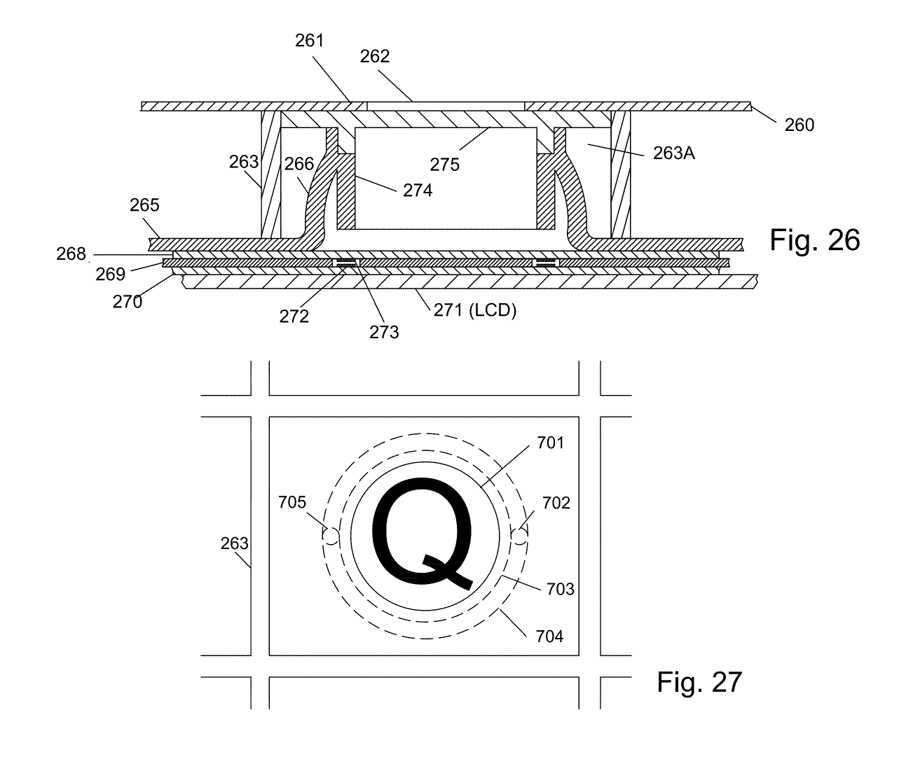

FIG. 26 shows a cross-sectional view of a key within a sub-surface keyboard with an external flexible transparent overlay. It is understood that a keyboard implemented in accordance with the embodiment of FIG. 26 could include multiple instances of the illustrated key mechanism to create a keyboard with multiple keys. The keyboard includes external flexible transparent overlay 260, which may be comprised of a flexible silicone film. Portion 261 (cross-hatched) of overlay 260 is non-transparent (such as painted), while portion 262 is transparent. Sliding platform 275 is retained within compartment 263A by guiding walls 263, which are provided by a guidance matrix, such as that illustrated in FIGS. 24-25. Sliding platform 275 compresses flexible dome 266 formed in elastic layer 265, such that sliding platform 275 rests against the underside of overlay 260. Elastic layer 265 further includes stem 274, extending from sliding platform 275 towards contacts 272 and 273. The contact mechanism in the embodiment of FIG. 26 is a three layer sandwich comprised of layers 268, 269 and 270, and contacts 272 and 273, operating to detect a key press similarly to, e.g., the embodiments of FIGS. 22-23 as previously described.

In the embodiment of FIG. 26, a portion of LCD display 271 is viewable through the key and overlay mechanism. Accordingly, overlay portion 262, sliding platform 275, and layers 268, 269 and 270 are either transparent and/or cut away such that they enable light emitted from LCD 271 to travel upwards through overlay portion 262.

FIG. 27 illustrates a top view of a portion of a keyboard implemented using the key mechanism of FIG. 26. A portion of subsurface matrix 263 is disposed beneath a non-transparent overlay having transparent portion 701 to enable viewing of an underlying portion of an LCD display. Broken lines 703 and 704 define the inner and outer circumferences of keycap stem 274 (FIG. 26). Contact switches 702 and 705 are disposed beneath stem 274.

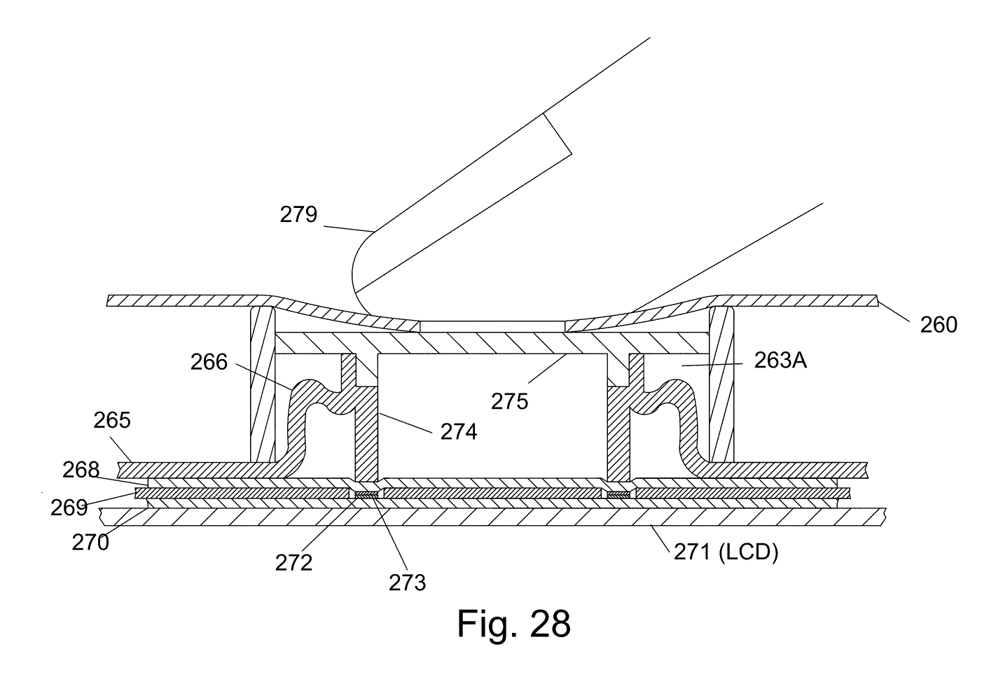

FIG. 28 illustrates the mechanism of FIG. 26, when the key is being depressed by a user's finger 279. Flexible overlay 260 deforms downwards in response to pressure from finger 279, thereby moving sliding platform 275 downwards within compartment 263A and collapsing flexible dome 266. Cylindrical stem 274 presses against layer 268, forcing contacts 272 and 273 against one another, to close a circuit, thereby indicating activation of the key associated with keycap 275.

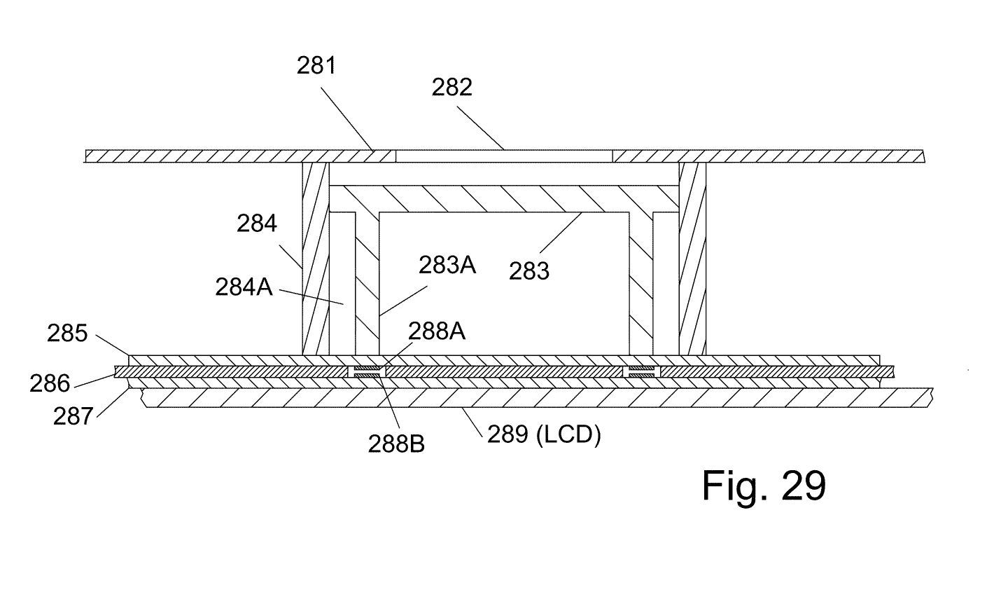

FIG. 29 shows a different embodiment of a sub-surface keyboard which doesn't have a flexible dome such as dome 266 in FIG. 28. The tactile resistance and the restoring force are provided by the external overlay itself. Specifically, flexible external overlay 281 includes transparent portion 282. Guiding walls 284 form receptacle 284A, within which keycap 283 is contained. Keycap 283 includes cylindrical stem 283A oriented generally perpendicularly to flexible external overlay 281. Keycap 283 normally rests upon the three-layer structure comprised of layers 285, 286 and 287, and electrical contacts such as 288A and 288B. This three layer structure is structurally and functionally analogous to three layer switch structures described in detail in other embodiments above. The walls 284 of the guidance matrix are the backbone that supports the structure. LCD 289 lies beneath layers 285, 286 and 287. A portion of LCD 289 is visible through external overlay transparent portion 282 and keycap 283, at least a portion of keycap 283 also being preferably transparent, such that a key symbol or other information associated with depression of keycap 283 is displayed to a user.

In operation, if a user pressed on external overlay portion 282, external overlay 281 stretches and deforms downwards, thereby applying pressure to keycap 283. Keycap 283 and cylindrical stem 283A move downwards, collapsing contact 288A against contact 288B to close a circuit and indicate activation of keycap 283.

It is understood that the systems described in this invention can be implemented with an underlying LCD screen, but also with an OLED display, digital ink (e-ink) display or any other type of display.

The embodiment of FIG. 29 has some major advantages because it does not require a dome or other relatively bulky structures under the surface of overlay layer 281. Those structures are in conflict in many cases with the efforts to reduce the thickness and the weight of portable devices. The embodiment of FIG. 29 can potentially be made thinner and lighter than embodiments that require domes, springs or other bulky structures under the surface.

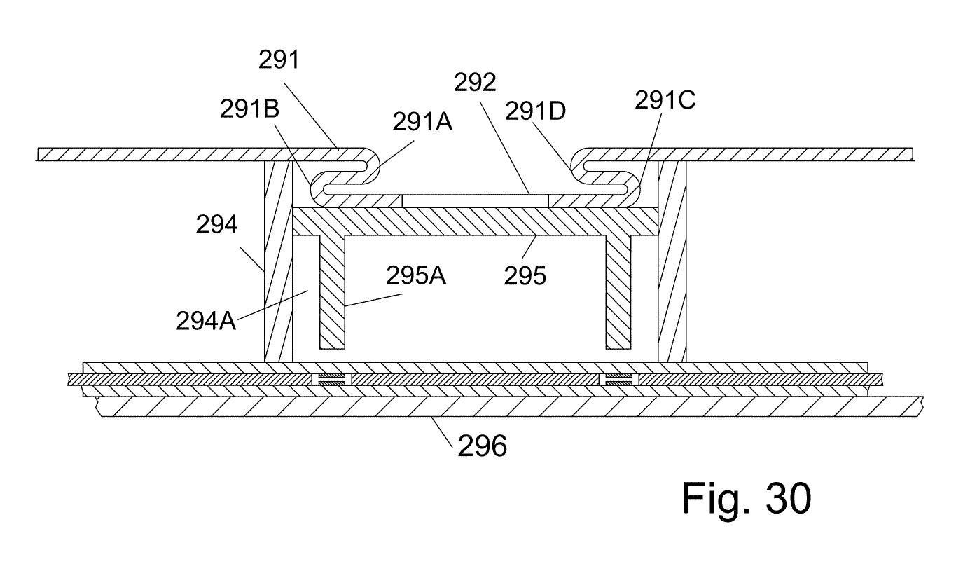

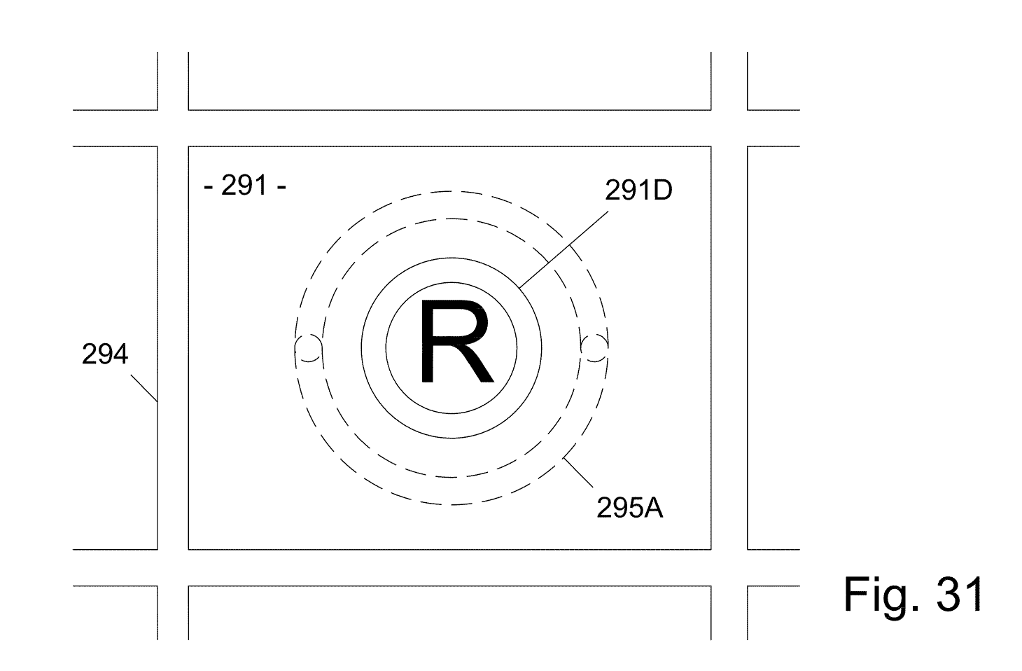

FIG. 30 shows a cross-section of a key mechanism for a different embodiment of a sub-surface keyboard without a flexible dome. The resistance and the restoring force are provided by an external overlay that is folded like a diaphragm. For example, flexible external overlay 291 includes folds 291A, 291B, 291C and 291D, such that overlay transparent portion 292 rests adjacent keycap 295. Keycap 295 includes stem 295A. Keycap 295 moves within receptacle 294A formed by receptacle walls 294, in response to depression of external overlay portion 292. External overlay folds 291A, 291B, 291C and 291D provide normal downward force against keycap 295 to maintain keycap 295 within receptacle 294A. FIG. 31 shows a top plan view of the key mechanism of FIG. 30. Subsurface matrix 294 and keycap stem 295A lie beneath flexible external overlay 291. External overlay 291 folds downwards at fold 291D.

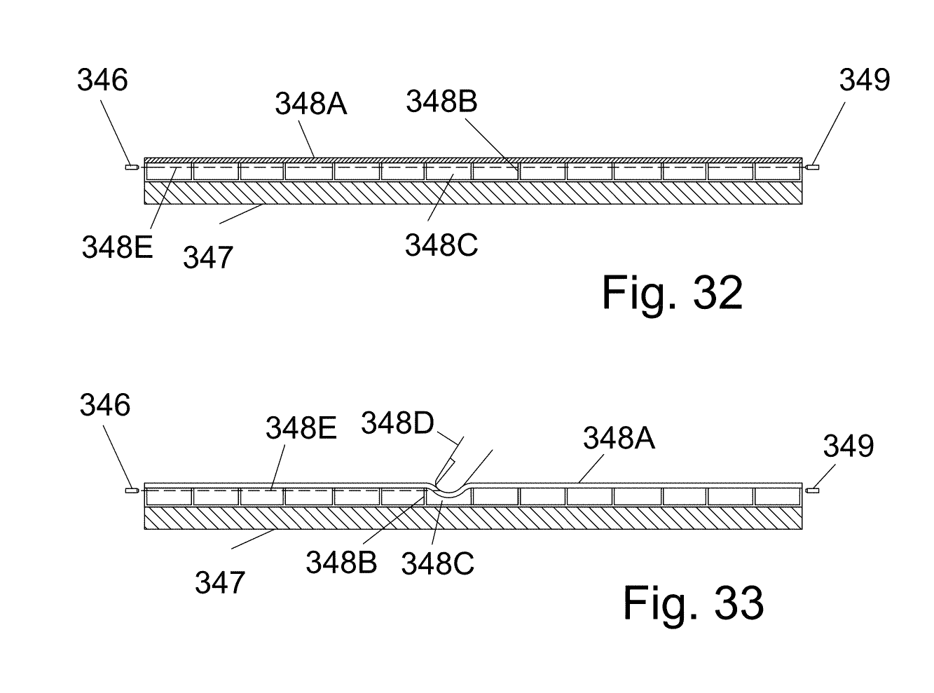

In some embodiments, key actuation can be detected via means other than direct closing of an electrical contact. For example, FIG. 32 shows a cross-section view of a variation of the sub-surface keyboard that uses light beams to detect actuation of a key. Light gun 346 is positioned beneath external overlay surface 348A, oriented to project an infrared beam parallel to surface 348A, towards infrared signal receptor 349. The light beam from light gun 346 passes through matrix 348B, which is analogous in structure to matrix 200 of FIG. 32 and which forms a plurality of compartments 348C which each correspond to a key. When surface 348A remains in a resting position, light from light gun 346 is received at receptor 349, thereby indicating that none of the keys corresponding to compartments 348C are being actuated by a user.

FIG. 33 illustrates the keyboard of FIG. 32, when a user 348D depressed external overlay 348A above compartment 348C formed by matrix 348B. External overlay 348A elastically deforms downwards into compartment 348C. Intrusion of user 348D into compartment 348C interrupts light beam 348E. The small but perceivable elastic deformation an elastic resistance of overlay 348A provides the sensation of a yielding key, thus giving the desired tactile feedback to the user. At the same time, the interruption of light ray 348E is reported by receptor 349 and interpreted by the touchscreen processor.

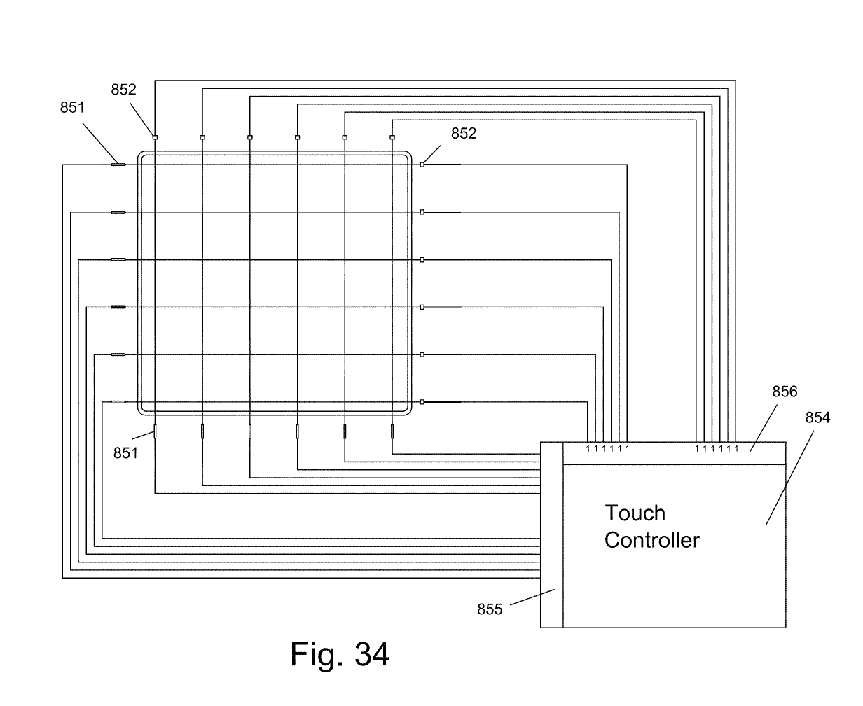

As illustrated in FIG. 34, the keyboard includes an array of light guns 851 and receptors 852 in both X and Y directions, such that each depression of a compartment interrupts two light rays. The processor can assign coordinates along X and Y axes to the point of touch to uniquely identify which key was pressed. Touch controller 854 includes an output module 855 connected to light emitters 851. Touch controller input module 856 receives signals from receptors 852. When light passes undisturbed between an emitter and receptor, input module 856 reports a signal indicative of a closed circuit.

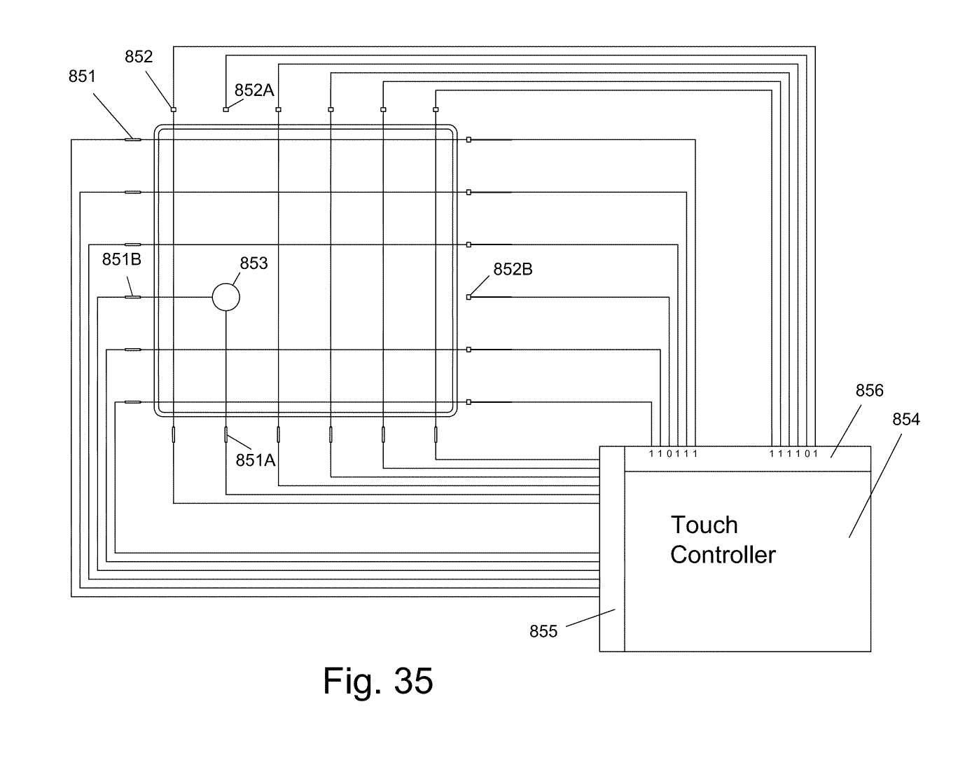

FIG. 35 provides a schematic illustration of the arrangement of FIG. 34, when a user's finger has made contact with a key at position 853. Light from emitter 851A is interrupted and prevented from reaching receptor 852A. Light from emitter 851B is interrupted and prevented from reaching receptor 852B. Receptors 852A and 852B emit signals indicative of an open circuit. Touch controller 854 processes signals received at input module 856 to identify the key actuated by the user, and report the key identification to the tablet computer CPU.

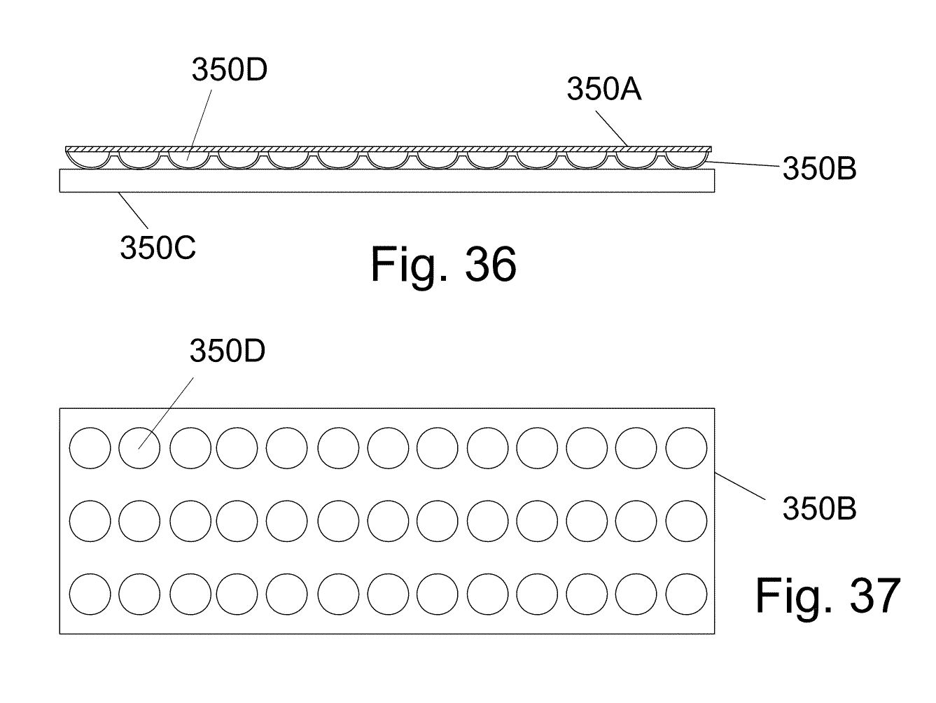

FIG. 36 illustrates another embodiment having a different subsurface matrix structure for defining key areas. Specifically, external overlay 350A covers matrix structure 350B. LCD 350C lies beneath matrix 350B. In the embodiment of FIG. 36, matrix 350B is shaped in a rounded, wavy pattern having a plurality of concave depressions 350D, rather than a set of criss-crossing walls extending perpendicularly down from the overlay as in other embodiments above. Providing a continuously curved matrix 350B reduces the visibility of the matrix to a user, which could be desirable in embodiments having a fully-transparent top membrane. Additionally, the curvature of the matrix can also act as a set of lenses to magnify the appearance of key labels displayed on LCD display 350C. FIG. 37 is a top plan view of curved matrix 350B, with concave depressions 350D.

While certain optical effects caused by the curvy matrix in FIG. 36 may be desirable in some applications, in other applications it may be preferable to minimize optical distortions of the underlying LCD.

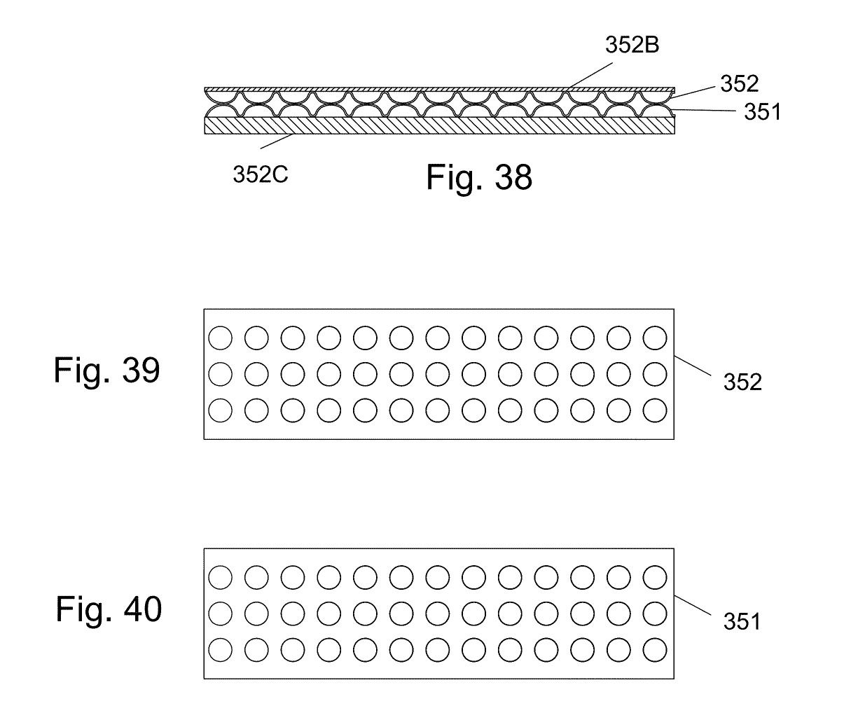

FIG. 38 shows another embodiment that may serve to reduce optical distortions of an underlying LCD. The embodiment of FIG. 38 includes two curved matrixes 351 and 352, disposed between overlay 352B and LCD 352C. Matrixes 351 and 352 are generally mirror images of one another across a plane parallel to overlay 352B.

FIG. 39 provides a top plan view of curved matrix 352, while FIG. 40 provides a top plan view of curved matrix 351.

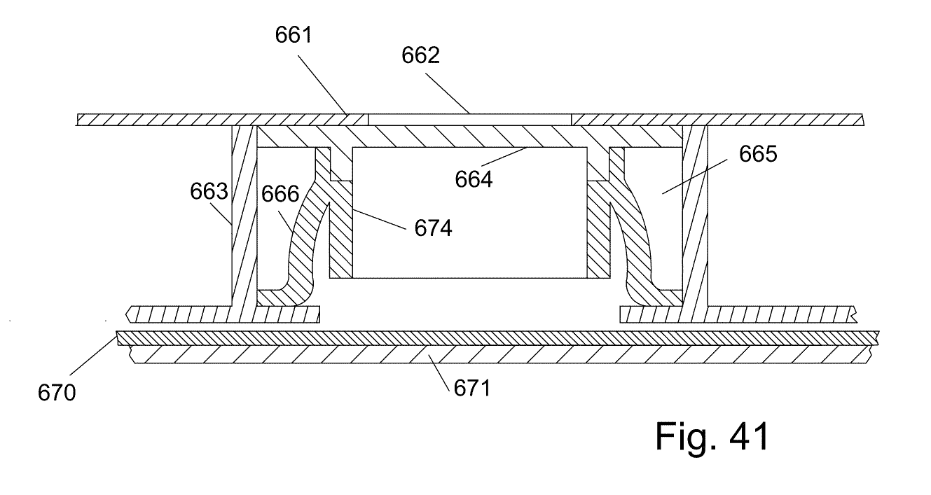

FIGS. 41-43 show an embodiment of a subsurface keyboard that works in conjunction with a touchscreen display panel, but which also provides tactile to a user upon contact with a key. This will be referred to as the tactile touchscreen keyboard.

FIG. 41 shows a sub-surface keyboard with a flexible external membrane 661 featuring transparent area 662, which allows a user to see a portion of display panel 671 for display of a symbol indicative of the function associated with depression of sliding platform 664. Sliding platform 664 is normally biased towards the underside of external overlay 661 by elastic dome 666 and stem 674. Elastic dome 666 and stem 674 are maintained within compartment 665 by subsurface matrix 663. Stem 674 is comprised of a material that enables contact detection by touchscreen surface 670, such as a conductive material.

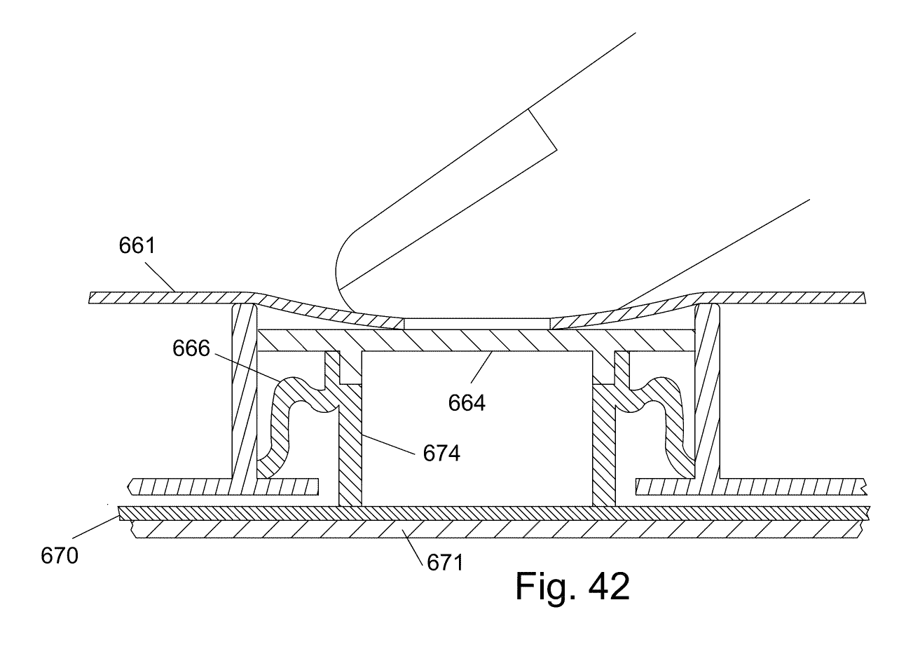

When the key mechanism of FIG. 41 is depressed by the user, as illustrated in FIG. 42, external overlay 661 deforms downwards, and sliding platform 664 collapses elastic dome 666 and cylindrical stem 674 contacts touchscreen 670. Contact of stem 674 with touchscreen 670 signals depression of the key associated with sliding platform 664.

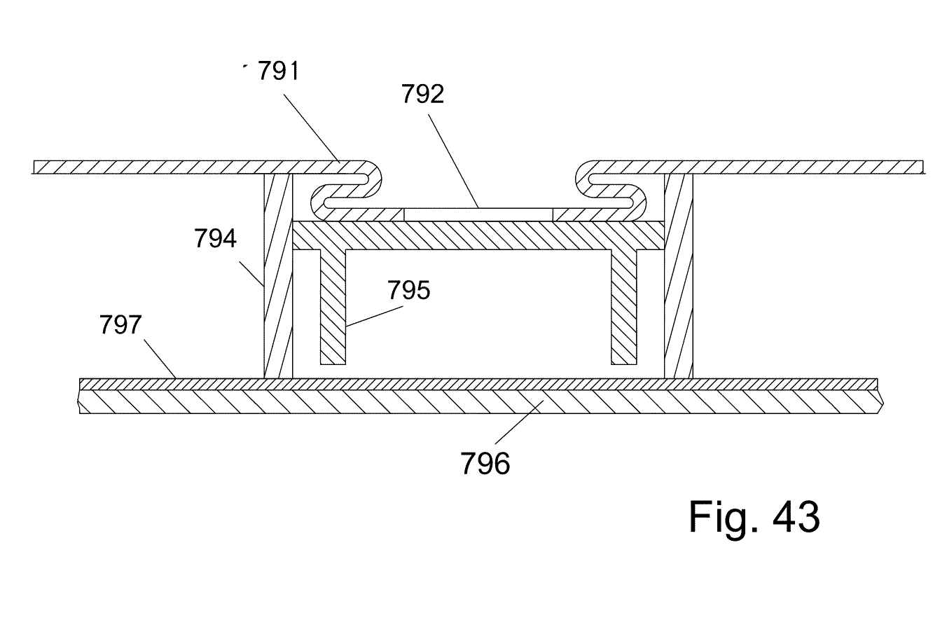

FIG. 43 shows another embodiment of a sub-surface keyboard with touchscreen display, which relies on a folded external membrane for tactile feedback, rather than a collapsible dome. Specifically, external membrane 791 includes a see-through area 792 that enables the user to see a key symbol or other label displayed on LCD panel 796 underneath. Rather than using a collapsible dome, overlay 791, which is folded like a diaphragm, provides the resistance and the restoring force, similarly to the embodiment of FIG. 30, described above. When the key is depressed by a user, the cylindrical plunger 795 contacts touchscreen 797 to signal actuation of the key.

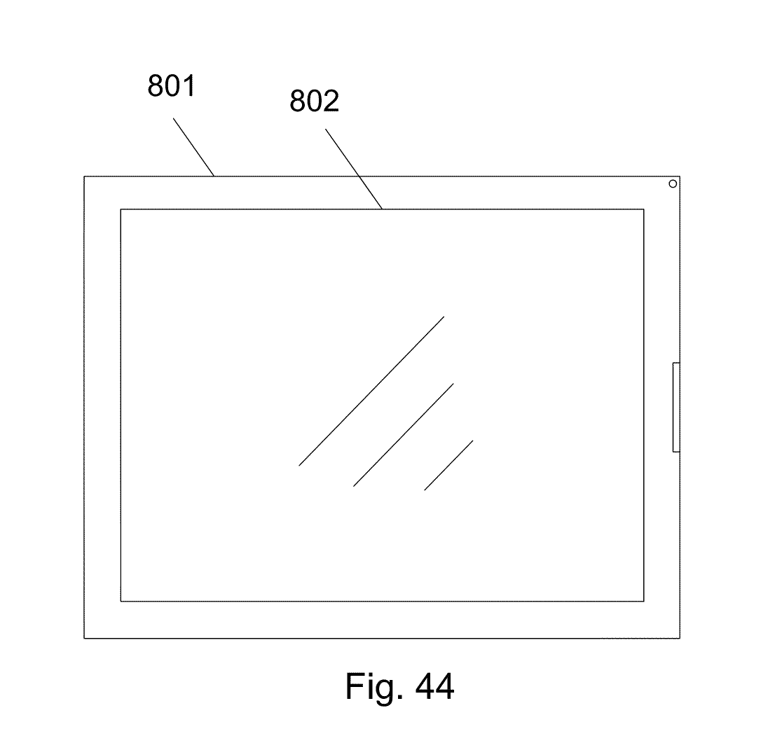

FIGS. 44-60 show a different type of tablet configuration which does not require a tradeoff of physical area for the primary display and keyboard. The keyboard also does not necessarily require a separate display screen. Rather, the keyboard shares its area with the primary display screen, still providing true tactile feedback, while also enabling the entirety of the display screen area to be used for other purposes when keyboard entry is not necessary.

FIG. 44 shows a front view of the tablet according to the present embodiment. This tablet computer includes a housing 801, and a fully functional touchscreen 802. Touchscreen 802 may be implemented using a variety of known touchscreen technologies (resistive, capacity, saw, infrared or other) and preferably supports all necessary touchscreen functionality (such as multipoint touch, gesturing, etc.). Touchscreen 802 further includes a subsurface keyboard beneath at least a portion of the screen, which provides fast and accurate tactile input. As can be seen in FIG. 44, the external appearance of the tablet is similar to a conventional tablet, with a primary display consuming the majority of the device top surface area and without a need to sacrifice display size to accommodate a dedicated keyboard area.

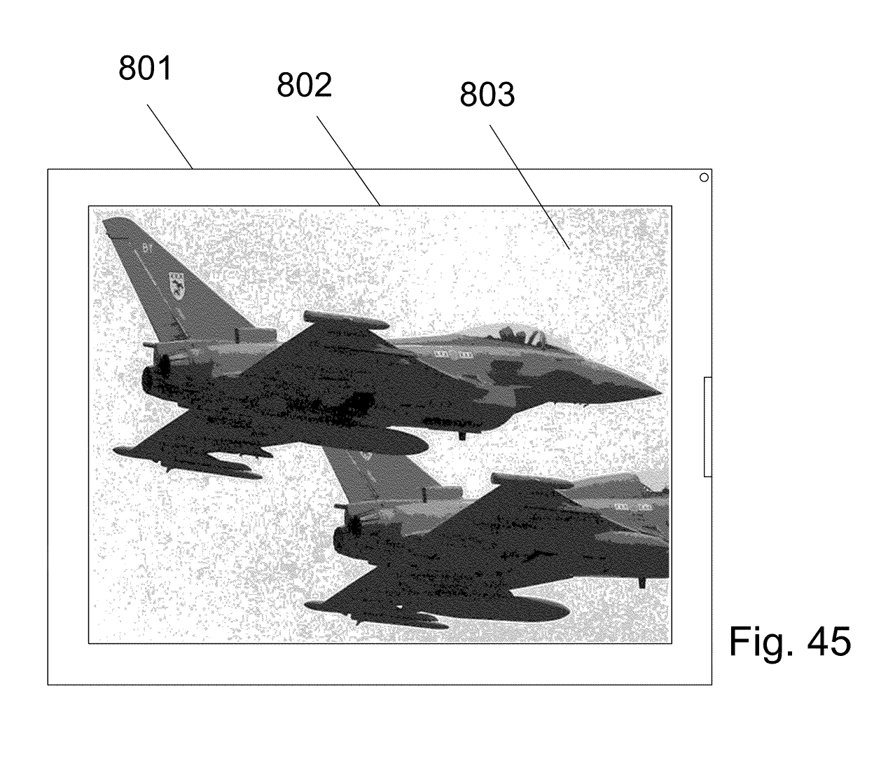

FIG. 45 shows the tablet of FIG. 44 being used in full display mode. In this case the user is watching a movie. The entirety of display 802 is available for displaying the movie.

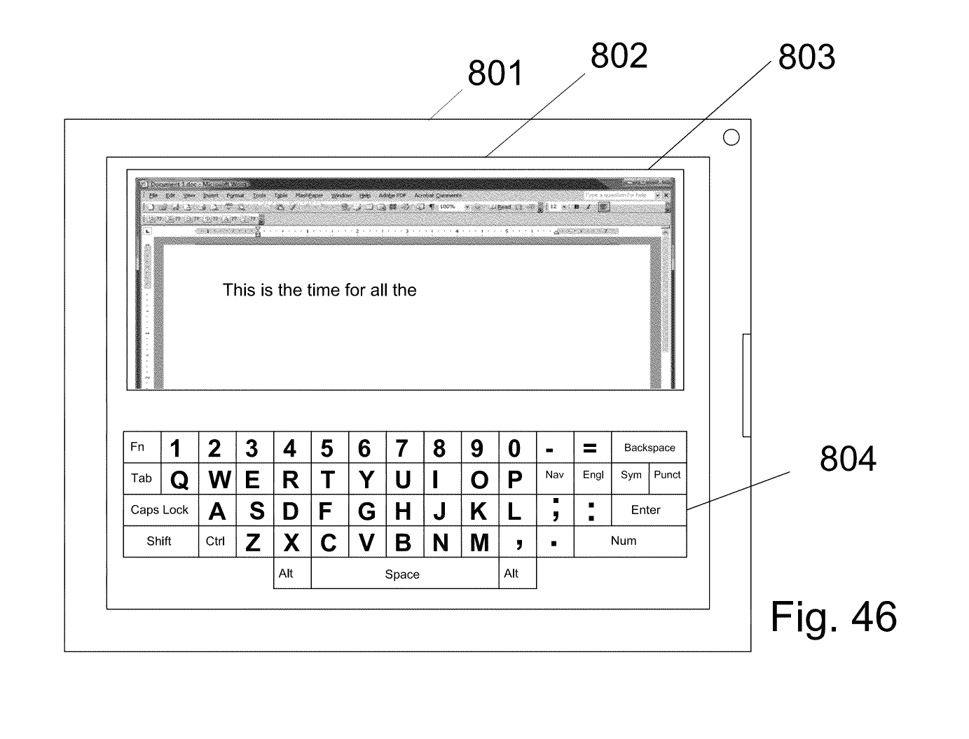

FIG. 46 shows the tablet of FIG. 44 in typing mode, such as during operation of word processing software. The upper portion 803 of display 802 shows the software interface to enter the text. The lower portion 804 is the image of a keyboard which is displayed on the screen, indicating to the user where the subsurface keys are located.

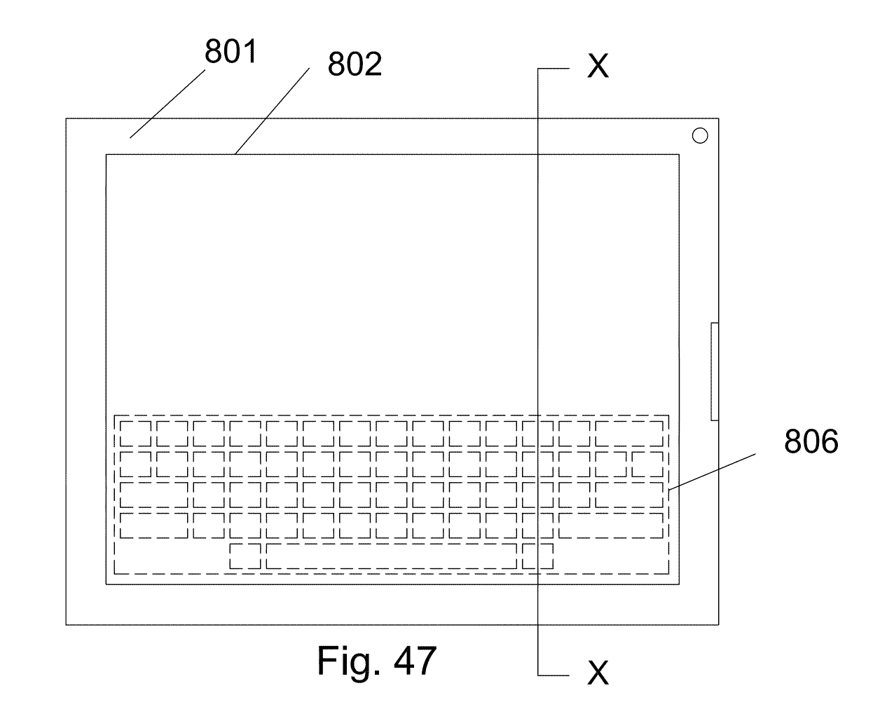

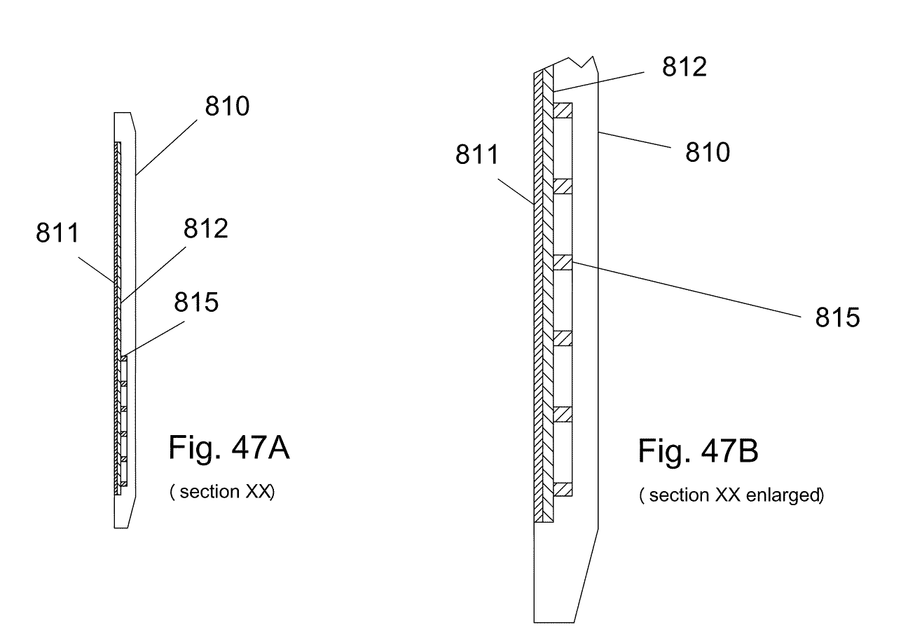

FIG. 47 is another front view of the tablet that also shows (in dotted lines) the guidance matrix 806 underlying display 802. Guidance matrix 806 constitutes the basic structure of the subsurface keyboard, to the extent that it provides opportunities for tactile feedback by varying the response of display 802 to surface pressure applied thereto.

FIG. 47A shows a cross-section of the tablet along line X-X. The cross-section shows an LCD display 812 (which could alternatively be implemented using other display technologies, such as an OLED display, or a digital ink/e-ink display) with a touchscreen film 811 attached to it. Both the display and the touchscreen film are flexible and elastic. Behind the display there is a guidance matrix 815. Guidance matrix 815 is analogous to the guidance matrix illustrated and described in connection with FIGS. 24-25, although in the embodiment of FIG. 47A, guidance matrix 815 defines five rows of key spaces rather than the three rows defined by the guidance matrix embodiment in FIGS. 24-25. Guidance matrix 815 is retained in a fixed position within the tablet, with the walls of guidance matrix 815 abutting the rear surface of display 812. The presence of guidance matrix 815 prevents portions of film 811 and display 812 abutting guidance matrix 815 from deforming downwards in response to a user pressing on the front surface of the screen. The portions of film 811 and display 812 positioned between the walls of guidance matrix 815 can be deformed downwards in response to a user's touch due to the flexible nature of film 811 and display 812. Thus, guidance matrix 815 enables a controlled and accurate deformation of the assembly of display 812 and touchscreen film 811 when the user pushes the front surface of the device.

FIG. 47B is an enlarged cutaway view of the lower portion of the tablet of FIG. 47A, further illustrating the relationship between touchscreen film 811, display panel 812 and guidance matrix 815.

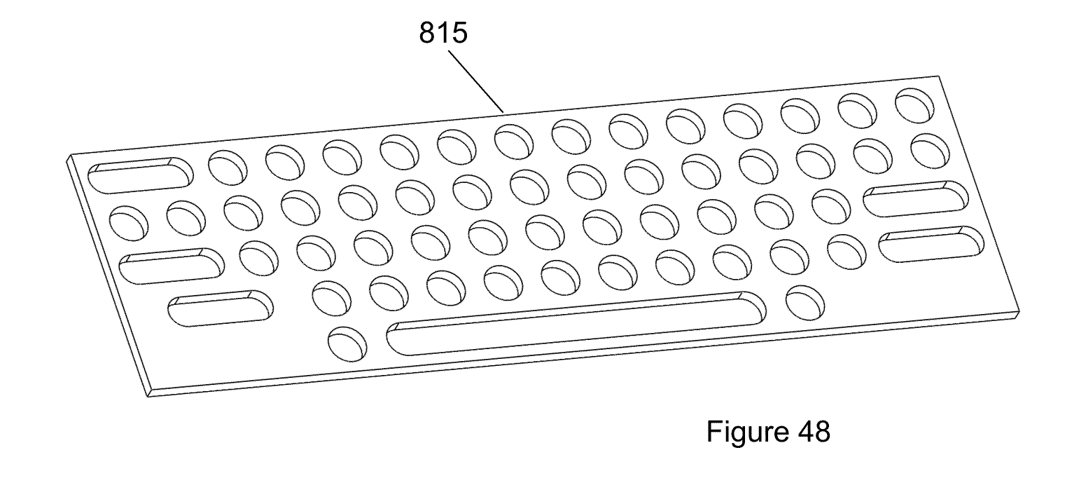

FIG. 48 is a perspective view of guidance matrix 815, which is a structure with cavities in the locations where the keys are located. The matrix guides and forces the user to touch the keys at the correct locations. It helps avoid triggering multiple keys with one touch, because it insulates one key from the neighboring keys. The guidance matrix also helps provide the tactile response that the user expects for fast and accurate typing on a keyboard. Guidance matrix 815 can provide a protective function as well, because otherwise a user could exert excessive force on a key, causing damage to the tablet internals; the matrix can provide a barrier than protects the internals from such occurrence. As can be observed in FIG. 48, the cavities have different shapes and/or sizes to match the image of the keyboard that can be presented on display 812. In the embodiment of FIG. 48, the cavities are formed as simple convex shapes in cross-section, such as circular or elongated oval. This keyboard can be implemented as a dynamic keyboard, in that the tablet software can display any desired labels on the screen and the user input will be understood and interpreted according to the key symbol being displayed at that time of a key press.

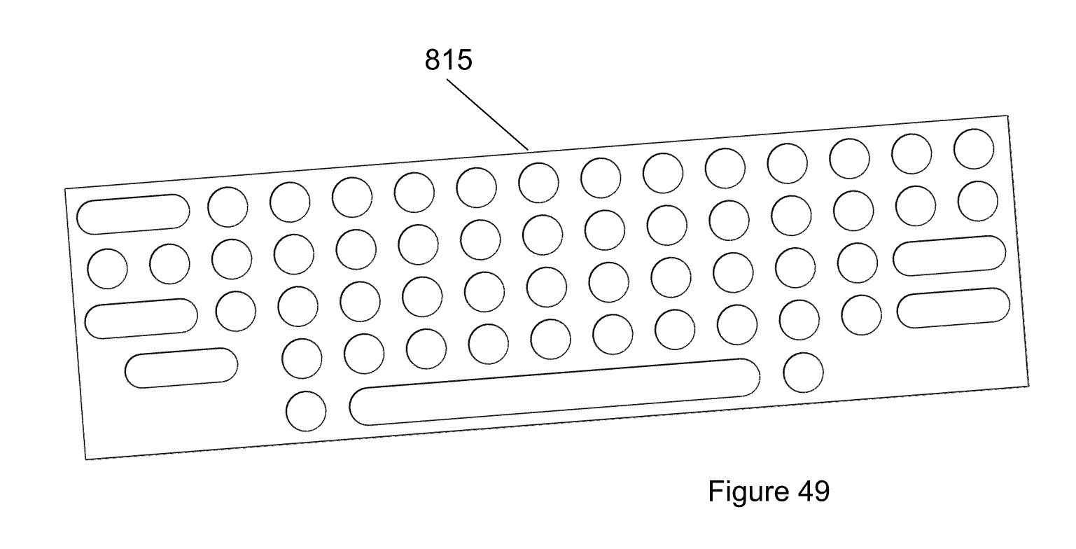

FIG. 49 is a front view of guidance matrix 815.

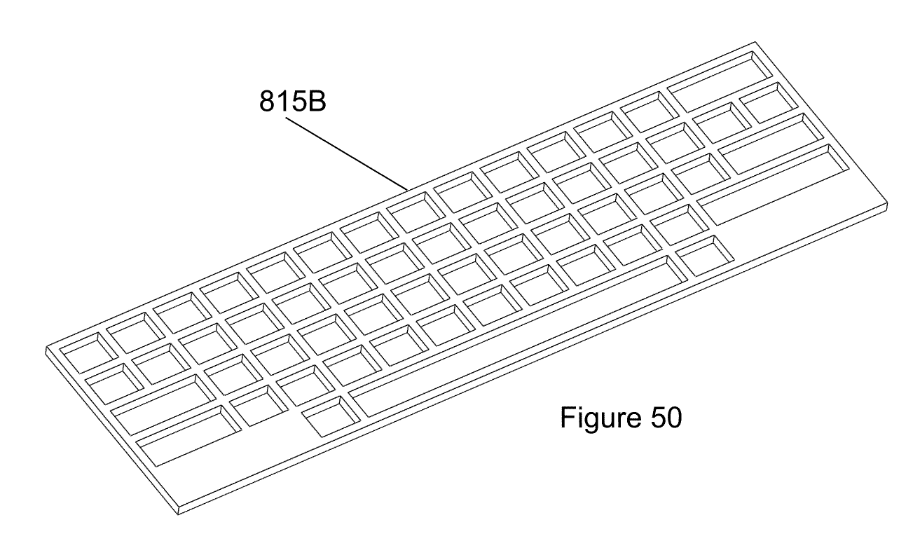

While guidance matrix 815 features rounded cavities within a flat layer of material, which in some embodiments may be a convenient or ergonomically desirable form to match the fingertips of a user, it is contemplated that alternative structures can be implemented to provide localized areas of deformation for an adjacent flexible display screen. For example, FIG. 50 is a perspective view of an alternative guidance matrix embodiment 815B. Guidance matrix 815B is formed from a flat layer of material with cavities quadrilateral in cross-section (and generally forming cavities that are quadrilaterally-faced hexahedra when considering the depth of the guidance matrix), to define a grid from a series of horizontal and vertical walls. The cavities within guidance matrix 815 are smaller in area than those of 815B, leaving more material in the guidance matrix layer to abut an adjacent display and further limit the portions of the display available for deformation in response to a user's press. It is contemplated that a variety of different shapes and sizes can be employed for the guidance matrix based on preferences and priorities for the relevant application.

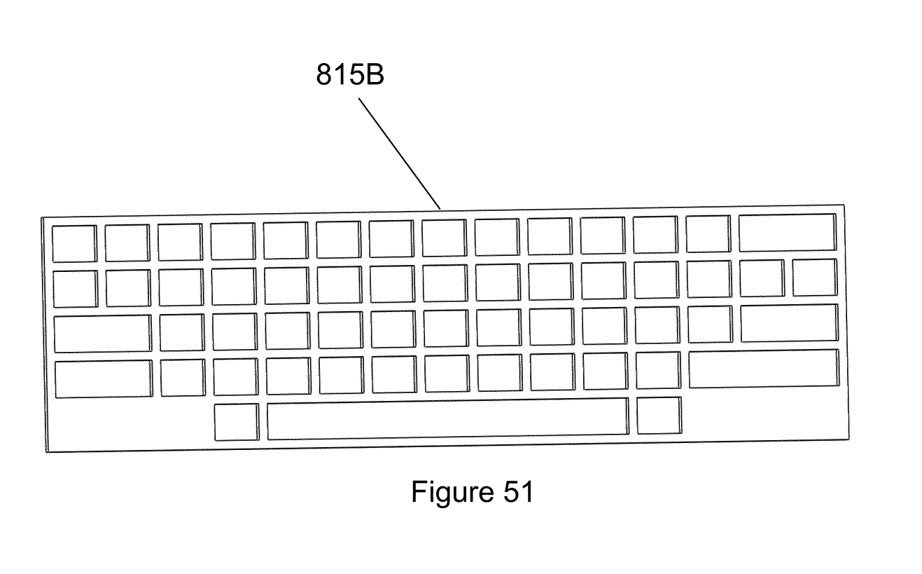

FIG. 51 is a front view of guidance matrix 815B with rectangular cavities.

The variation in physical support underlying a flexible display assembly provided by a guidance matrix provides a first level of tactile feedback. It is contemplated that the guidance matrix assembly can be utilized in varying ways, alone or in connection with other structures. For example, it may be desirable to implement sub-surface key structures within the cavities of the guidance matrix. Subsurface key structures can provide, for example, increased resistance to physical depression of a key area on the display and increased restorative force. Subsurface key structures can also enable implementation of alternative, physical switch actuation mechanisms (rather than mere contact with the touch screen) to provide users with a more certain physical trigger of a key and potentially avoid inadvertent key presses.

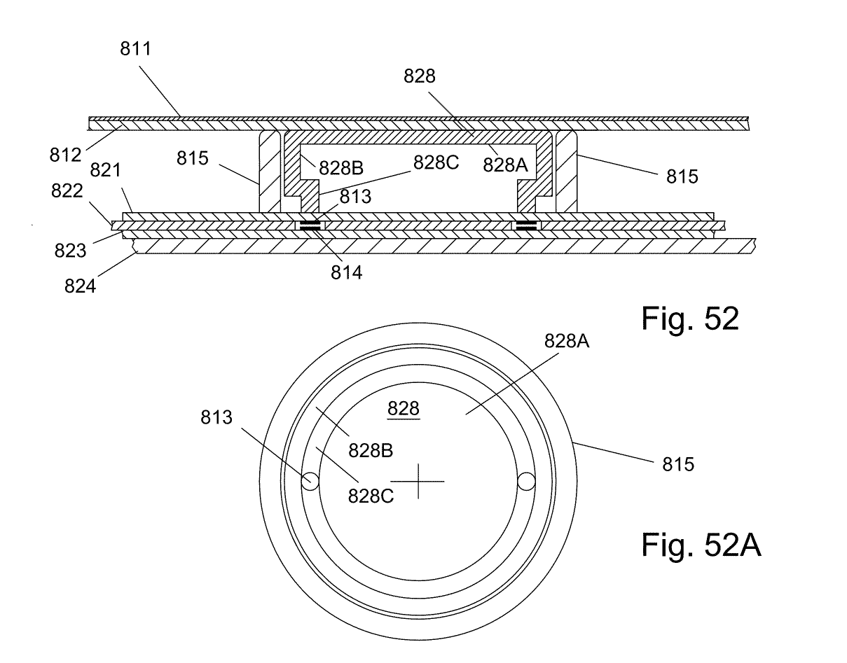

FIG. 52 is a cross-section of an exemplary subsurface key mechanism implemented within with a guidance matrix beneath a portion of a flexible display screen. Touch sensitive film 811 lies atop flexible display 812. Guidance matrix 815 lies beneath and adjacent to display 812. A key cap 828 lies within a cavity formed by guidance matrix 815. Key cap 828 includes a flat top surface 828A which lies adjacent the underside of display screen 812, as well as a first perpendicular wall 828B extending downwards from top surface 828A generally proximate and parallel to the walls of guidance matrix 815. Key cap 828 further includes a second perpendicular wall 828C which is attached to perpendicular wall 828A and extends further downwards, away from top surface 828A. Preferably, the radius (i.e. distance across) perpendicular wall 828C is less than that of perpendicular wall 828B, such that the keycap contacts contact switch layer 821 at a position offset from guidance matrix wall 815 (and therefore offset from the comparable structure of an adjacent key), thereby reducing the opportunity for inadvertent activation of a switch associated with an adjacent key. The key 812 rests on top of the 3-layer switch set that comprises a) layer 821 with its attached electric contact 813, b) layer 823 with its attached electric contact 814 attached to it, and c) insulating layer 822 which has the mission to normally maintain a gap between contacts 813 and 814. 824 is the bottom of the cavity in the tablet housing that contains and houses the above-described subsurface keyboard mechanism.

FIG. 52A is a top view of the key mechanism of FIG. 52. Guidance matrix 815 surrounds keycap 828, with the periphery of first perpendicular wall 828B generally adjacent to the inner wall of a cavity within guidance matrix 815. While FIGS. 52 and 52A illustrate an embodiment having circular key caps and circular cavities within the guidance matrix, it is contemplated that alternative embodiments of this key mechanism could readily be implemented using other shapes, such as the quadrilateral cavity guidance matrix of FIGS. 50-51 and key caps sized to fit therein.

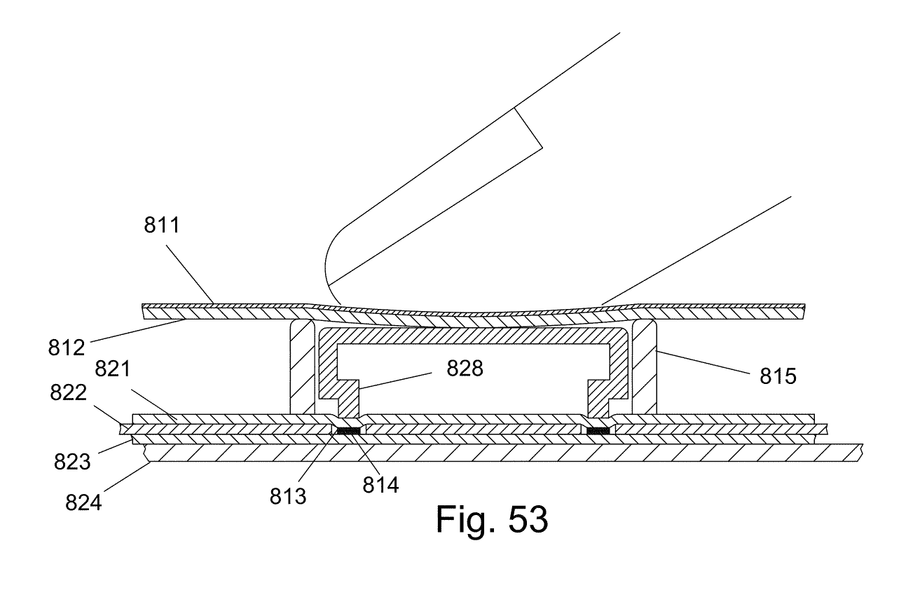

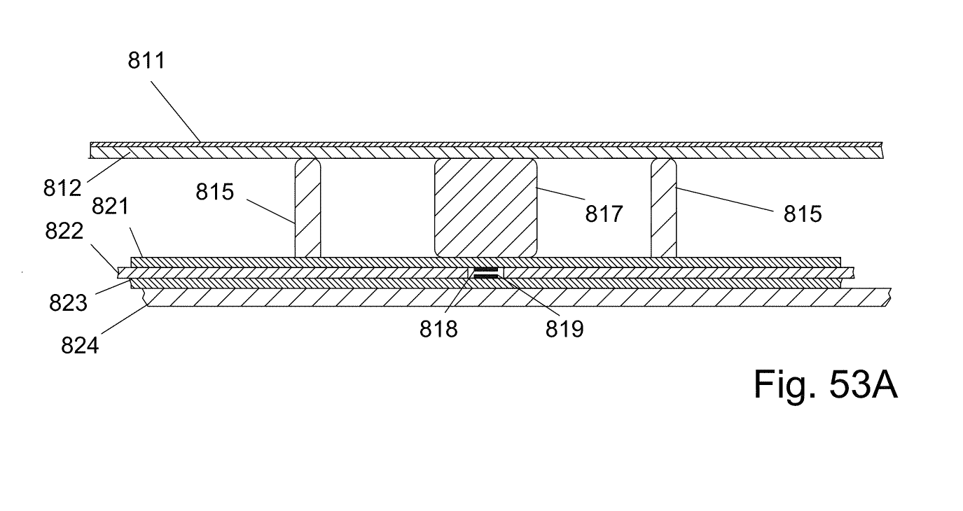

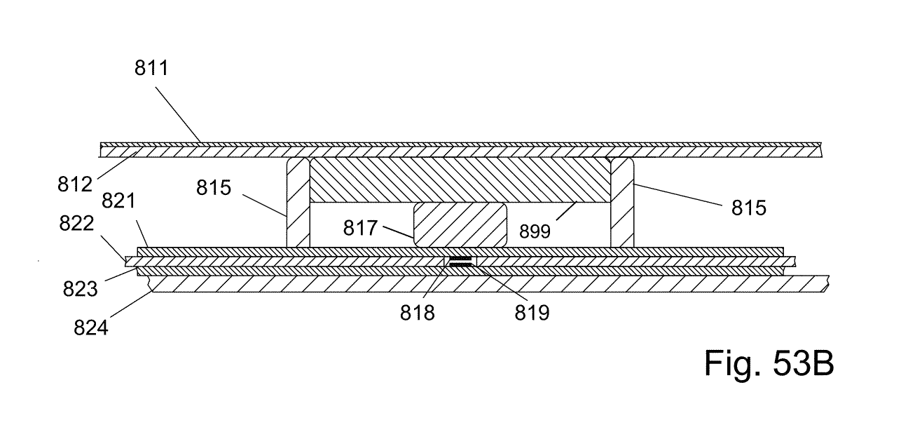

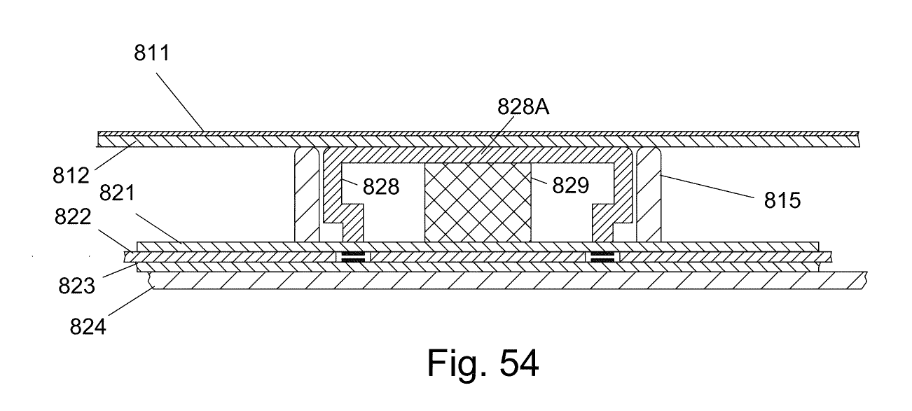

FIG. 53 shows that when the user presses on the external touchscreen 811 and the attached flexible LCD display 812, touchscreen 811 and display 812 slightly deflect downwards, thereby push down the adjacent key 828, compressing the layer 821 against layers 822 and 823 until the electrical contacts 813 and 814 touch one another, generating an electric signal that the processor interprets as the key having been pressed. This embodiment relies on the flexible LCD panel 812, the touchscreen 811 and the 3-layer switch package 821, 822 and 823 to provide together the resistance to the depression that gives the user the tactile feedback feel, as well as to provide the restorative force that returns the key and all layers to their non-actuated positions when the user-applied force ceases.

In principal restorative force can be generated through the use of collapsible domes of the type used to provide restorative key force in conventional keyboards, but that may be difficult or disadvantageous due to the limited space availability in tablets and the common desire to manufacture thin tablet devices. Domes are used in laptops and other keyboards where space is not as limited as in tablets. For tablets, smartphones and other mobile devices, the device thickness is critical.

FIG. 53A shows another embodiment of the invention wherein only one pair of contacts 818 and 819 is used for each key, preferably centrally located relative to the cavities of the guidance matrix 815. Button 817 is positioned within a cavity of guidance matrix 815, between the underside of display 812 and the top side of three layer switch structure of layers 821, 822 and 823. When the user pushes the touchscreen 811 and the flexible LCD screen 812, downward pressure is applied to switch layers 821, 822 and 823 through button 817, compressing the two contacts 818 and 819 together. Button 817 may be comprised of a compressible elastic material for tactile response.

FIG. 53B shows another embodiment wherein the button 817 is located underneath a plunger or key cap 899. Plunger 899 is positioned beneath flexible display 821, and contained within the cavity of guidance matrix 815. The plunger 899 can implement several functions, such as: a) it guides the button 817 in its downward movement, because the plunger is itself guided by the walls 815, therefore ensuring a smooth straight descent minimizing lateral forces and lateral displacements which otherwise could lead to, e.g., misalignment of the contacts 818/819; and b) it provides support to LCD 812 and the touchscreen 811, maintaining a smooth and flat outside top surface, which is important to facilitate the proper operation of the touchscreen when the device is used in touchscreen mode rather than keyboard mode.

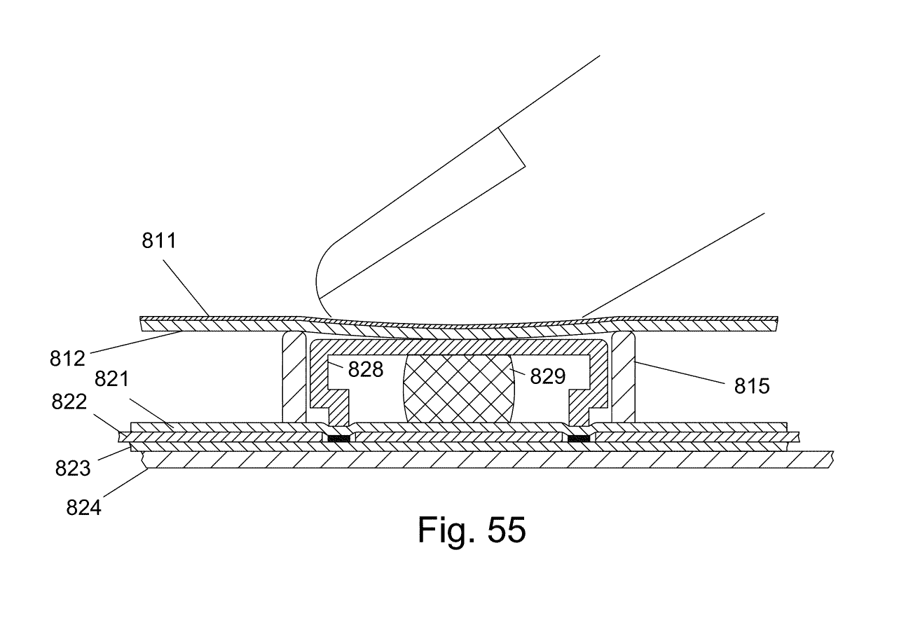

FIG. 54 is a cross-sectional view of a variation of the previous embodiment shown in FIGS. 52 and 53, which includes an additional mechanism for providing increased resistance to depression of the key cap, as well as increased restorative force to move the key cap back into its resting position once the key is released by the user. Block 829 is positioned beneath the underside of key cap top surface 828A, and preferably has a resting height approximately equal to the distance between key cap surface 828A and layer 821. Block 829 is formed from a material that is readily subject to elastic deformation in response to compression by the force of a user's finger, such as a foam or rubber. FIG. 55 shows the key being depressed by the user, which causes an elastic deformation of the foam block 829 as the foam block 829 is compressed in height due to downward movement of key cap 828 relative to the portion of layer 821 against which block 829 abuts. The compressive force of block 829 acting against key cap 828 (and in turn display 812 and touch screen 811) helps provide resistance and restoration forces.

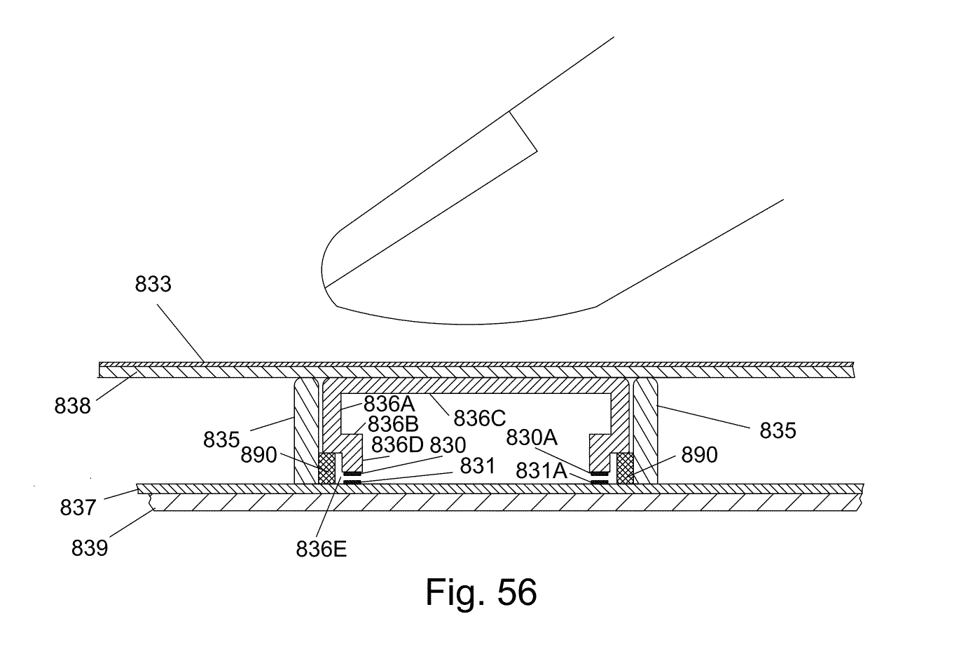

FIG. 56 shows in cross-section another embodiment of a subsurface key mechanism enabling use of an alternative structure for providing restorative force to the key cap, as well as enabling use of alternative switch mechanisms. The top surface of the tablet computer includes touch screen membrane 833 and flexible display panel 838. Guidance matrix 835, analogous in shape and structure to guidance matrices described elsewhere herein, underlies display 838. The walls of guidance matrix 835 provide support and guidance to the electrically conductive key 836. Key 836 includes: top portion 836A, the outer circumference of which is proximate the inner cavity wall of guidance matrix 835; transition portion 836B, which preferably runs parallel to top portion 836C; and lower portion 836D, the outer circumference of which is small in diameter than the inner cavity wall of guidance matrix 835, thereby providing a gap 836E between keycap 836, guidance matrix 835 and underlying layer 837. Key cap lower portion 836D has electrical contacts 830 and 830A attached to its bottom, confronting contacts 831 and 831A which are attached to a single sheet 837 which contains the circuit traces of the keyboard electrical diagram. Layer 839 provides physical support to the structures above. Elastic spacer 890 is positioned within gap 836E. Space 890 provides support between layer 837 and key cap transition portion 836B to maintain a small gap separating electrical 830 and 830A from electrical contacts 831 and 831A, respectively, in the absence of user-applied downward force on key cap 836. Spacer 890 is made from an elastically deformable material, such as foam rubber. Spacer 890 can be a circular ring with a rectangular cross-section that wraps around the inner cavity wall of guidance matrix 835, to which it can be attached by an adhesive or other means. When the user applies downward pressure to touch screen 833 and display 838 at a position above key cap 836, key cap 836 moves downward, compressing and slightly deforming spacer 890, descending until the electrical contacts 830/831 and 830A/831A establish contact, closing an electrical circuit that the keyboard processor (not shown) recognizes and interprets as the key having been actuated.

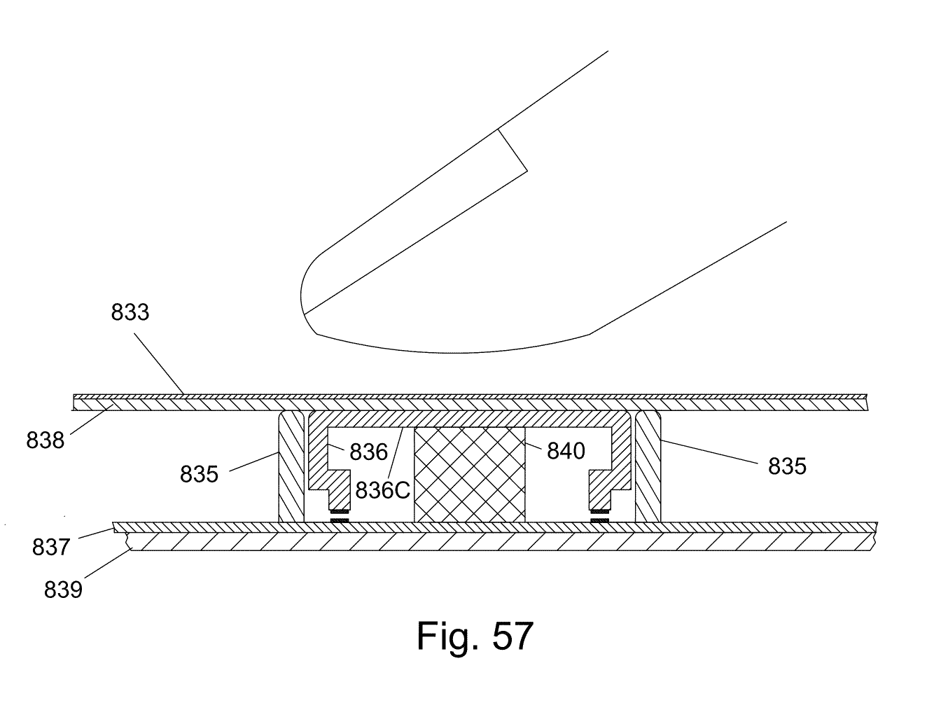

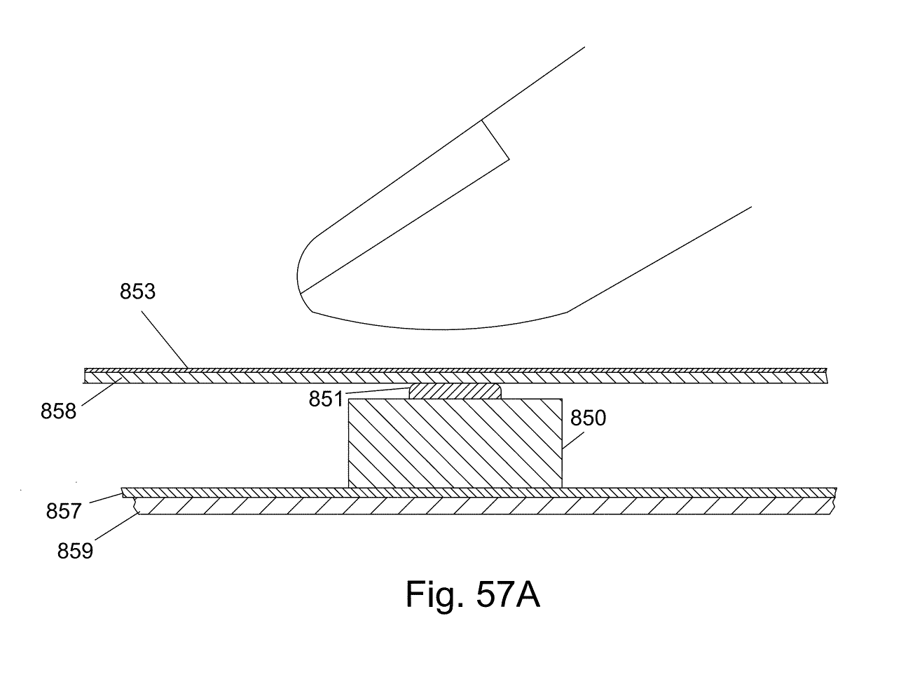

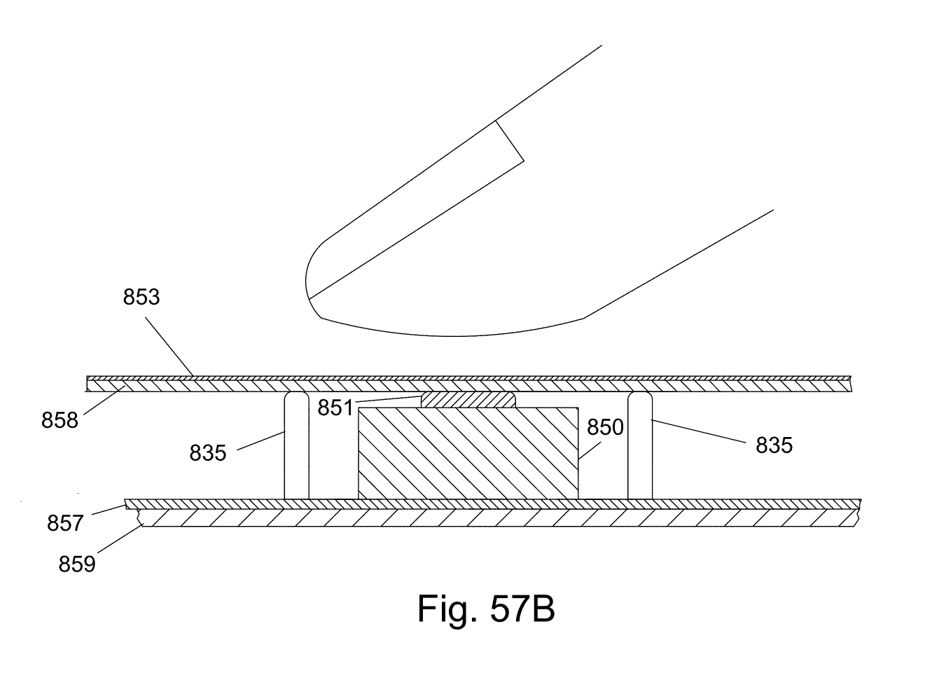

FIG. 57 is a variation of the previous embodiment, wherein elastic spacer 890 has been replaced with a central elastic block 840 positioned within a central portion of key cap 836, beneath key cap top surface 836C. Due to the increased space available beneath key cap top surface 836C compared to gap 836E in typical embodiments, central elastic block 840 may be larger than elastic spacer 890 of FIG. 56, thereby providing opportunities to implement greater resistance and better guidance to the key, as well as a higher restorative force.

While embodiments described above provide a generally rectangular guidance matrix, it is also contemplated that tablet computers may be implemented using a differently-shaped guidance matrix, or even multiple guidance matrixes. One particular application of this concept arises for tablet computers that are designed to be used in both landscape and portrait orientations. When moving between landscape and portrait orientations, the location of the displayed keyboard typically moves to maintain the keyboard location across the bottom of the screen; the key size and shape may also change to take advantage of available space.

FIG. 57A shows a different embodiment wherein under the flexible screen 858 there is a microswitch 850 (equipped with a button 851). The microswitch 850 is mounted on a board 857. The microswitch 850 can be a tactile microswitch, which provides a tactile feel, such as a click response, when its button 851 is depressed. While microswitch 850 is illustrated with button 851 directly underlying display 858, it is understood that intermediary keycap structures could be mounted between display 858 and microswitch button 851, or integrated with button 851 as a unitary structure; for example, to provide a uniform flat surface underlying display 858. The board 857 can be a printed circuit board (PCB) and the microswitch 850 can be attached to it with through-holes or preferably with surface-mount technology. The illustrated microswitch key assembly structure can be repeated beneath multiple portions of display 858 at which a tactile touch response is desired, such as for each key location in a software-controlled keyboard depicted on display 858.

FIG. 57B is another embodiment, which is very similar to the previous embodiment of FIG. 57A, but it also includes a guidance matrix with walls 835. Microswitch 850 is positioned within a cavity defined by guidance matrix 835. The inclusion of guidance matrix 835 may act to, e.g., a) guide the fingers of the user when using the keyboard by defining soft areas and hard areas (i.e. areas in which the screen surface is rigid and areas in which the screen surface is subject to downward deformation in response to user applied pressure); and b) provides support to LCD 858 and the touchscreen 853, helping maintain a smooth and straight outside top surface, which can be helpful to facilitate operation of the touchscreen when the device is used in touchscreen mode rather than keyboard mode.

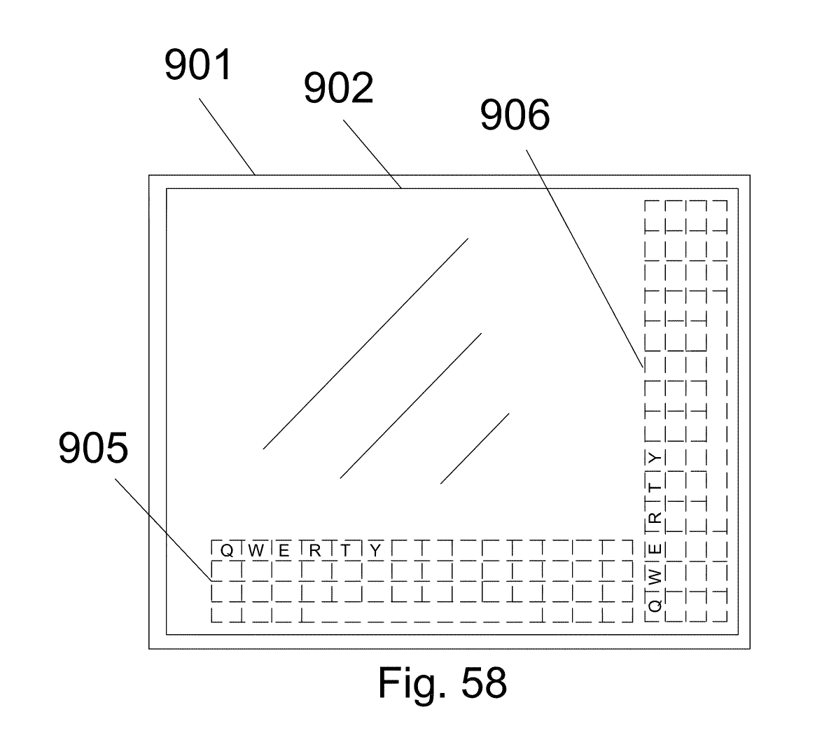

FIG. 58 shows such a tablet computer 902, implementing display screen 902. A subsurface guidance matrix underlying display 902 includes a first section 905 and second section 906. Subsurface guidance matrix first section 905 underlies a software-displayed keyboard during use of the tablet in landscape orientation, while guidance matrix second section 906 underlies a software-displayed keyboard during use of the tablet in portrait orientation. It is understand that subsurface guidance matrix first section 905 and second section 906 may be a single physical structure (e.g. a single backwards L-shaped structure), or alternatively first section 905 and second section 906 may be implemented from two separate pieces, each of which is similar to the guidance matrixes described in connection with, e.g., FIG. 24, 25, or 48-51.

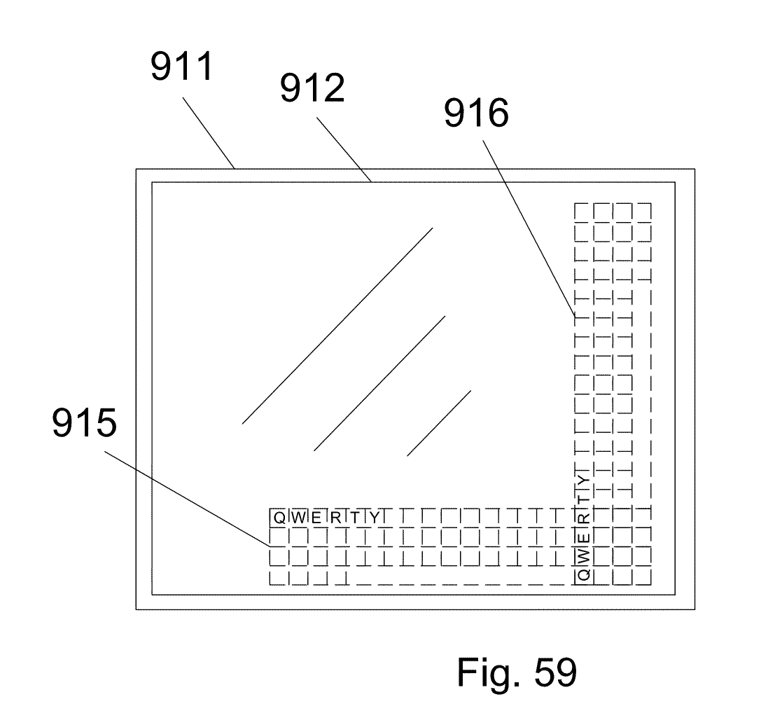

In some embodiments, it may be desirable for a guidance matrix to provide cavities which are utilized during use of the tablet in both landscape and portrait orientations. FIG. 59 is a variation of the previous embodiment, wherein the guidance matrix comprises two sections: a landscape portion 915 and a portrait portion 916, such that the two portions overlap. In the example depicted in FIG. 59, the last four columns of the landscape section are also utilized as the first four columns of the portrait section. This approach can be used to reduce the size of the guidance matrix, potentially contributing to cost and weight reduction. This approach can also be utilized to increase the amount of space available for the keyboards, as the guidance matrix can completely span the bottom portion of the display screen in both landscape and portrait orientations.

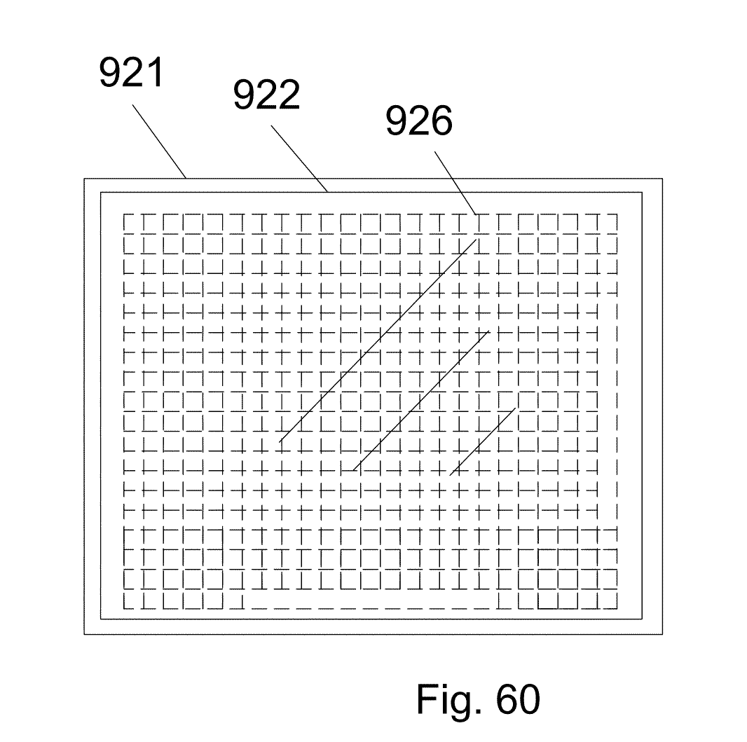

FIG. 60 shows another embodiment wherein the tablet has a guidance matrix that substantially covers the complete area under the tablet display, so that the user can enter data with tactile feedback at almost any location of the display. Tablet computer 921 includes display screen 922. Guidance matrix 926 defines a matrix of cavities underlying substantially all of display screen 922. Display screen 922 can therefore be utilized to display software-defined keys or other areas for touch-based input by a user, at substantially any location on display screen 922, while providing tactile feedback upon actuation by the user.

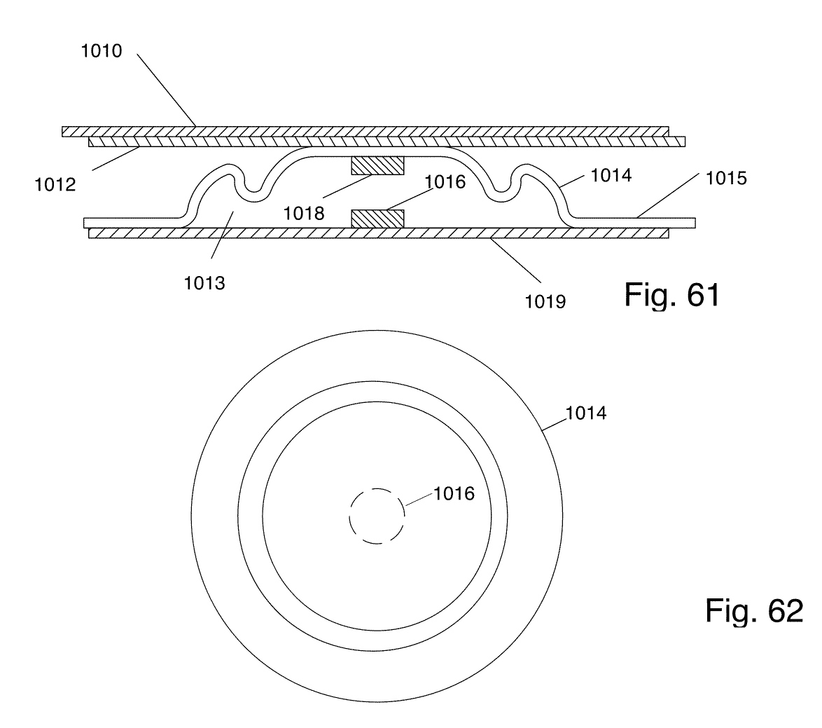

FIG. 61 illustrates a further embodiment of a tactile subsurface key structure suitable for implementation in a mobile device, such as a tablet or mobile phone. FIG. 61 is a cross-section taken perpendicularly to display panel 1012. Display panel 1012 may be formed from, e.g., a flexible OLED, a flexible LCD, or a flexible e-paper display. Transparent touchscreen 1010 overlies display panel 1012. A deformable tactile structure is provided beneath display panel 1012. The tactile structure includes top layer 1015 and bottom layer 1019. Top layer 1015 is comprised of an elastically deformable material, and forms one or more structures that extend perpendicularly away from bottom layer 1019. In the embodiment of FIG. 61, top layer 1015 includes collapsible diaphragm structure 1014, forming void 1013 between a portion of top layer 1015 and bottom layer 1019. Electrical contact 1018 is affixed to the bottom side of top layer 1015, at a location at which void 1013 separates top layer 1015 from bottom layer 1019. Electrical contact 1016 is attached to the top surface of bottom layer 1019, in a position vertically aligned with electrical contact 1018. When in an uncompressed state, diaphragm 1014 maintains an air gap between electrical contacts 1016 and 1018.

In some embodiments, it is contemplated that diaphragms 1014 are integral to top layer 1015, such that they are formed from a unitary material, which can be made of rubber, mylar or other non-conductive materials, with electrical traces on the layer to conduct electrical signals. In other embodiments, the diaphragms can be separate components affixed (e.g. via mounting, gluing, fusing, overmolding or otherwise) to top layer 1015. In such embodiments, diaphragms 1014 can be made of different materials from other portions of layer 1015, such as polymers, rubber, flexible plastic, metal or other elastic materials. The void 1013 between bottom layer 1019 and top layer 1015 can be air trapped between those layers to contribute to providing an elastic compressible volume. The bottom layer 1019 can be formed from a non-conductive material, such as plastic, with conductive traces on it to conduct electrical signals.

FIG. 62 is a top plan view of diaphragm 1014. Many different types of diaphragms can be implemented in various embodiments of the key structures contemplated herein. Diaphragm 1014 is made of an elastic material such as rubber or silicone, and is generally dome-shaped with a circumferential fold structure to increase soft travel range of the key structure as the diaphragm is collapsed. Other diaphragms may be made with different types of folds or shapes, or without any such folds. For instance, in other embodiments, the diaphragm can be shaped like a simple convex surface with a circular outer perimeter. In yet other embodiments, the diaphragm can be shaped like a convex surface with a polygonal outside perimeter where every corner of the polygon is a foot or support point. Many materials can be used to form the diaphragms, such as rubber, polymers, silicone, plastics and metals.

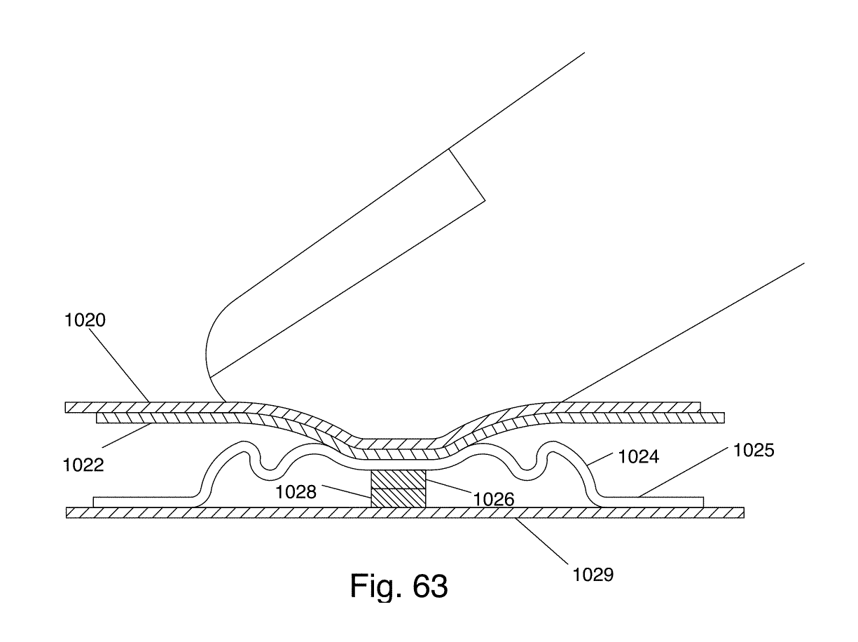

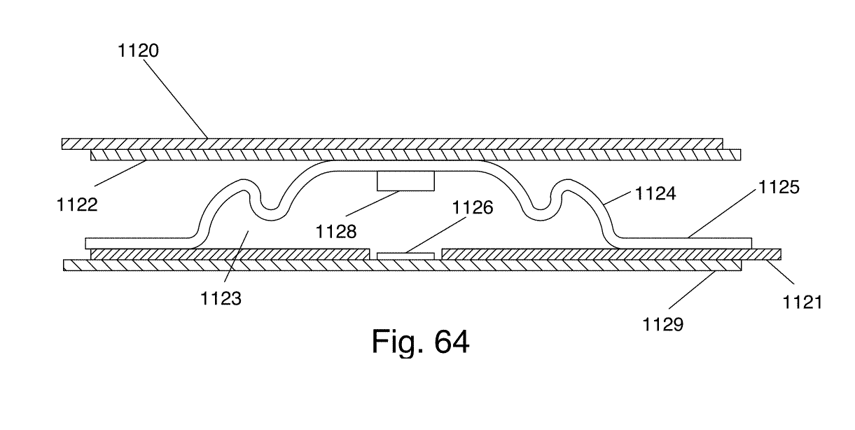

FIG. 63 shows the key structure of FIG. 61 in a compressed state. Downward force is applied by a user's finger to touchscreen 1020 and flexible display 1022, compressing and collapsing diaphragm 1024 until electrical contacts 1026 and 1028 contact one another, thereby generating a signal detected by a device microprocessor (not shown). When used in connection with a virtual keyboard function, the microprocessor can identify a character corresponding to the key press by correlating the position of the depressed diaphragm with the image displayed on display 1022 at the location corresponding to diaphragm 1024.

FIG. 64 shows another embodiment in which an additional insulating layer 1121 has been added to electrically separate and insulate top layer 1125 and bottom layer 1129 from one another. This structure can be useful when layers 1125 and 1129 include electrical traces (such as a printed circuit board) in order to convey electrical input signals to the device's microprocessor. Insulating layers 1125 and 1129 from one another may avoid inadvertent short circuits when traces touch each other, particularly during conditions in which a user is applying downward force to the display, which force may be transmitted to compress layers 1125 and 1129. Insulating layer 1121 includes a void surrounding electrical contact 1126, thereby allowing contact 1128 to connect electrically with contact 1126 when diaphragm 1124 is compressed, e.g. in response to downward pressure by a user. Void 1123 provides an air gap between contacts 1126 and 1128 when diaphragm 1124 is not in a compressed state.

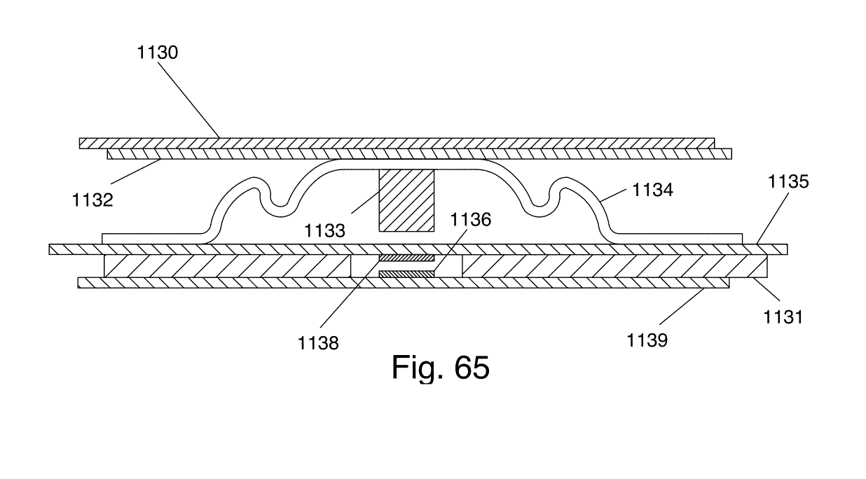

FIG. 65 illustrates in cross-section another embodiment in which a collapsible diaphragm overlies a three layer switch structure. Specifically, a device top surface is formed from touch sensitive layer 1130 and flexible display screen 1132. Raised diaphragm 1134 lies beneath display screen 1132. Beneath layer 1134 lies a three layer switch structure comprised of layers 1135, 1131 and 1139. Separation layer 1131 lies between layers 1135 and 1139, electrically insulating them from one another. Layer 1131 includes a void, within which electrical contact 1138 abuts the bottom side of layer 1135 and electrical contact 1136 abuts the top side of layer 1139, with a small air gap separating the contacts when layers 1135 and 1139 are in their normal, non-deformed positions. Push rod 1133 lies between the bottom side of diaphragm 1134 and the top side of layer 1135, at a location above electrical contact 1138.

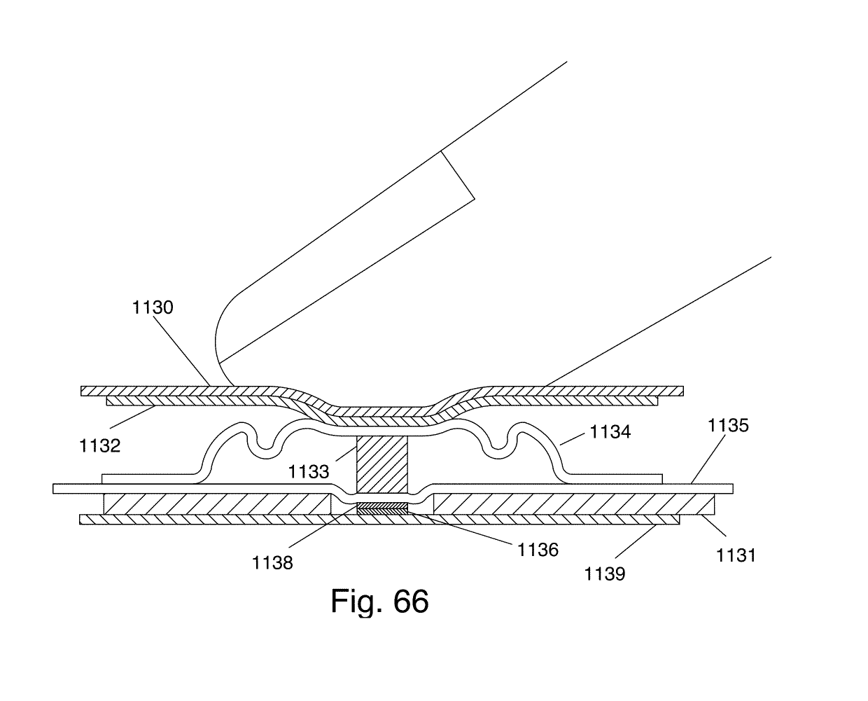

FIG. 66 illustrates the structure of FIG. 65 when the display is pressed by the user. Touchscreen 1130 and display screen 1132 yield, compressing diaphragm 1134. Diaphragm 1134 in turn transfers downward pressure on push rod 1133, which pressed down upon and deforms top layer 1135, moving contact 1138 until is collapses the air gap separating it from contact 1136, thereby closing a switch and generating a signal that can be detected by a device microprocessor.

While the embodiments of FIGS. 65 and 66 include a push rod between diaphragm 1134 and the layer beneath it, it is understood and specifically contemplated that other embodiments could eliminate the push rod. This may be particularly desirable in embodiments where the physical separation between display screen 1132 and the underlying switch structure is small, thereby enabling implementation of a thinner device for a given amount of “key travel”, i.e. distance that touchscreen 1130 and display screen 1132 can be deformed downwards to provide tactile feedback to the user.

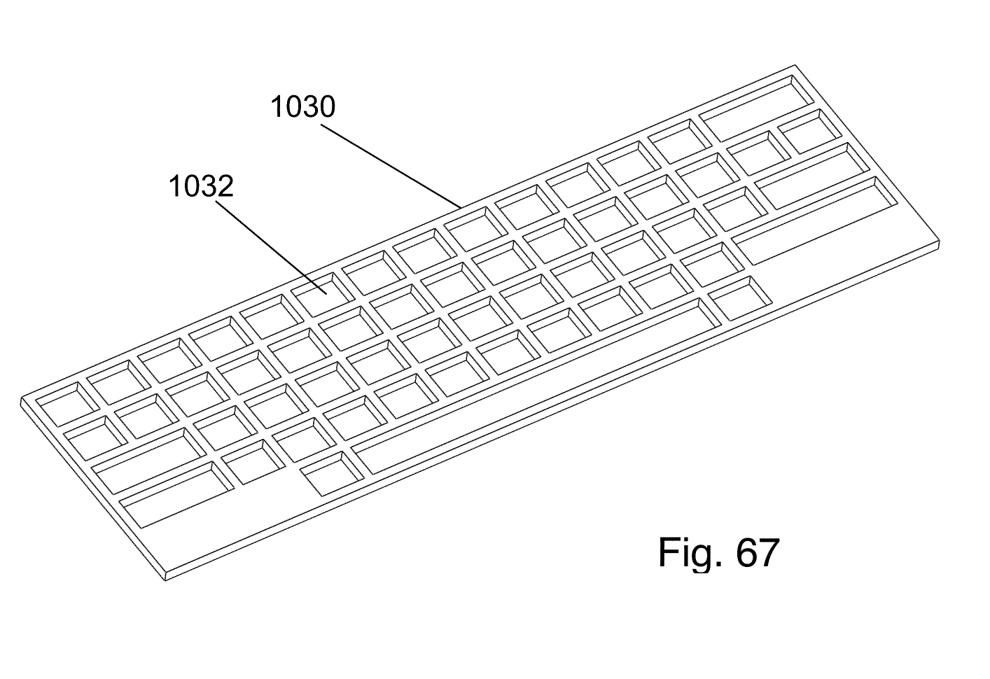

FIG. 67 is a perspective view of guidance matrix 1030, which is a subsurface grid that can be positioned beneath a flexible display panel to provide a user with tactile feedback when applying pressure to the display panel. For example, guidance matrix 1030 can be used to help guide and center a user's finger on available target locations by allowing downward deformation of a flexible display screen in areas overlying guidance matrix voids 1032, while inhibiting downward deformation of the flexible display screen in areas overlying guidance matrix walls. In embodiments having diaphragm structures analogous to those illustrated in FIGS. 60-66, positioning the diaphragms within guidance matrix voids 1032 helps avoid situations in which a user accidentally presses areas between diaphragm locations, or accidentally compresses more than one diaphragm with a single touch.

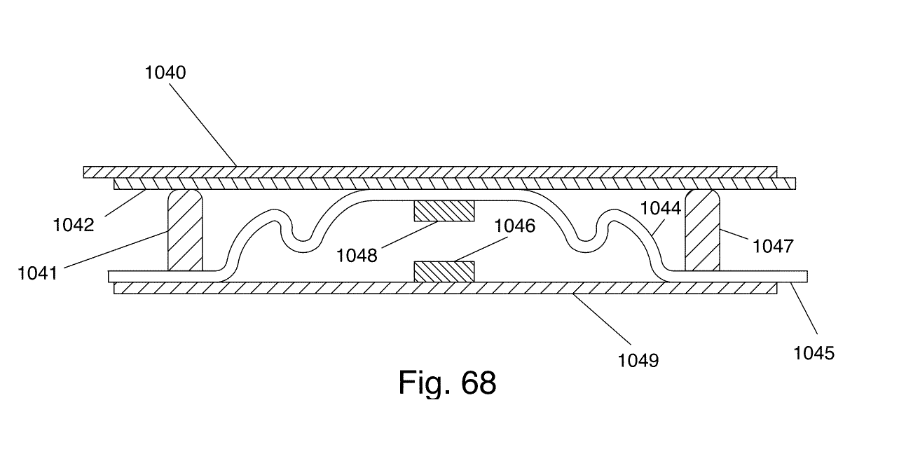

FIG. 68 illustrates a cross-section of a mobile device key structure utilizing a guidance matrix, such as that of FIG. 67. Touchscreen 1040 overlies display panel 1042. Guidance matrix walls 1041 and 1047 lie beneath display panel 1042, forming an open area in which diaphragm 1044 is formed within layer 1045. A portion of diaphragm 1044 extends proximate display panel 1042 and the top plane of guidance matrix walls 1041 and 1047, while other portions of diaphragm 1044 extend downwards towards the lower edges of guidance matrix walls 1041 and 1047. Electrical contacts 1048 and 1046 lie between diaphragm 1044 and underlying layer 1049, and are normally separated by an air gap when diaphragm 1044 is in a non-deformed position.

In the illustrated embodiment, layer 1045 extends beneath guidance matrix walls 1041 and 1047. That said, it is understood and specifically contemplated that other embodiments may include separate diaphragm structures, each positioned within a guidance matrix void, which structures may or may not be connected by a layer underlying the guidance matrix, such that the diaphragm layer may be contained wholly within a guidance matrix void.

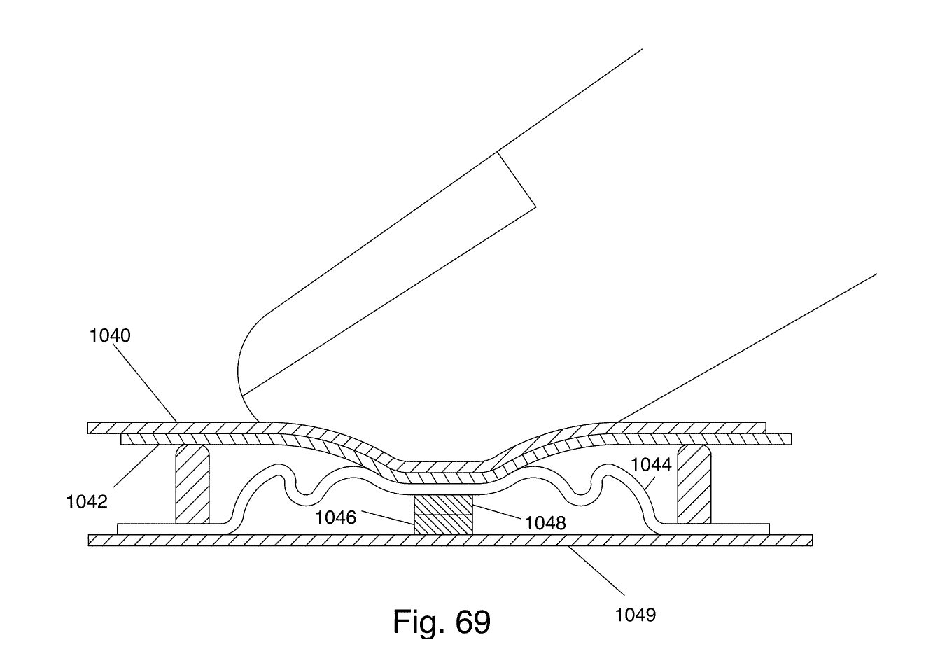

FIG. 69 illustrates the structure of FIG. 68 after a user's finger has applied pressure to the display. Downward force acts to deform touchscreen 1040 and flexible display panel 1042 towards support layer 1049, compressing diaphragm 1044 such that contact 1048 closes against contact 1046, thereby closing a circuit and indicating actuation.

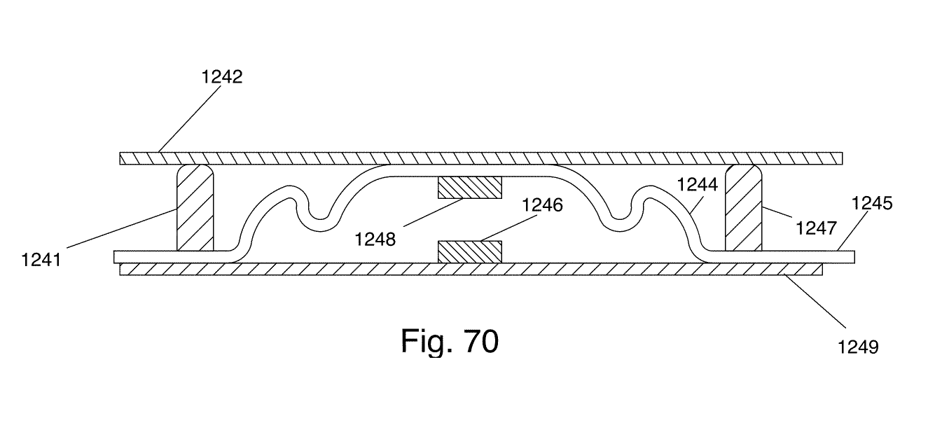

FIG. 70 is a cutaway cross-section of another embodiment of a mobile device with tactile touch sensitive display. In the embodiment of FIG. 70, the touchscreen layer (which was the outermost layer in the embodiments of FIG. 61-69) has been eliminated. However, implementation of touch sensitive subsurface structures maintains a touch responsive user interface, even without a traditional touch sensitive layer on the display. Display graphics are utilized to guide a user to touch desired locations, e.g. locations in which subsurface switch structures are provided. Flexible display screen 1242 lies above guidance matrix walls 1241 and 1247. Diaphragm 1244 is formed within layer 1245. Contacts 1246 and 1248 are positioned between diaphragm 1244 and support layer 1249, and are normally separated by an air gap when diaphragm 1244 rests in an uncompressed state. Flexible display 1242 may be implemented using a flexible OLED or AMOLED display that does not require a backlight and therefore can be made very thin and flexible. Several benefits can be achieved by eliminating the touchscreen layer, e.g. (a) the cost and complexity of providing the touchscreen layer is eliminated; and (b) the user can now view the display layer 1242 directly, without an overlying touchscreen degrading the display appearance due to imperfect optical clarity, particularly when subjected to staining, degradation under sunlight, discoloration, small scratches and wear. Thus, embodiments may enable a user to experience a higher quality, sharper image.

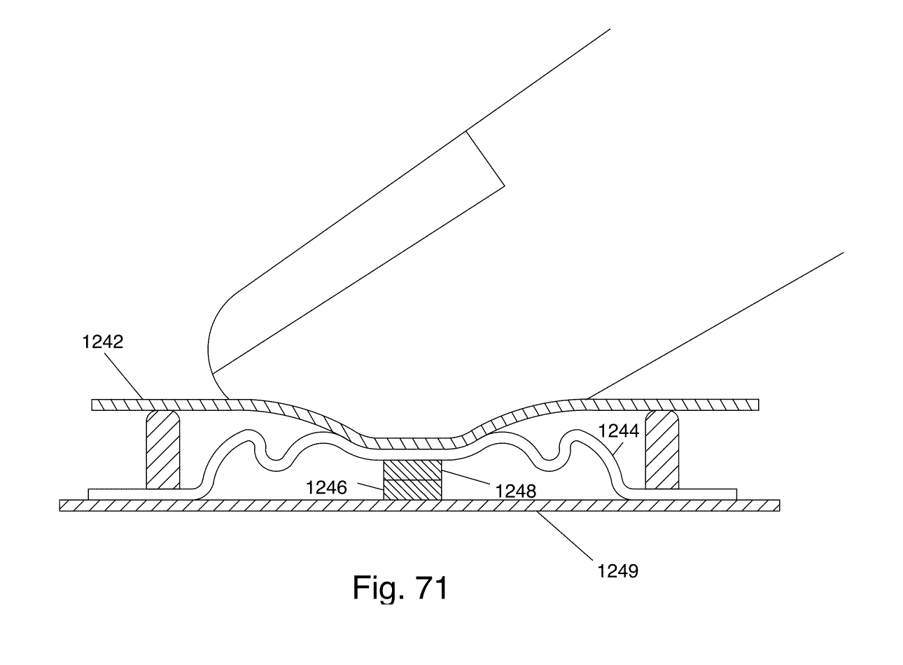

FIG. 71 illustrates the embodiment of FIG. 70 after a user's finger has compressed flexible display 1242, collapsing diaphragm 1244 towards support layer 1249 and causing electrical contacts 1246 and 1248 to contact one another, thereby closing a switch and indicating actuation. Since the location of contacts 1246 and 1248 relative to display screen 1242 is known to the device controller, the controller can identify the location of a user's touch even without a traditional touch sensitive layer. Subsurface contacts and associated collapsible structures can be implemented in a variety of desired densities and beneath any area of (or the entirety of) a display screen, with or without a guidance matrix, thereby potentially providing touchscreen functionality to an entire display.

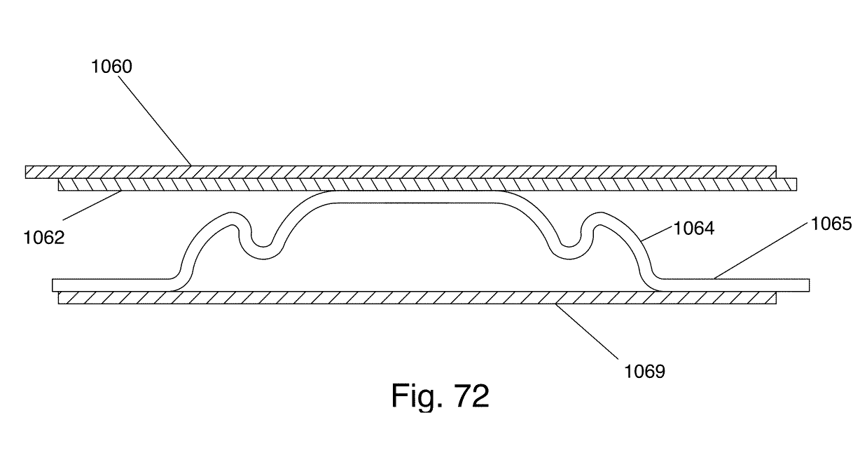

FIG. 72 is a cutaway cross-section of another embodiment of a mobile device having a subsurface tactile keyboard. In this embodiment, touchscreen layer 1060 overlies display screen 1062. Display screen 1062 is separated from support layer 1069 by a space. Layer 1065 and associated diaphragm 1064 lies within that space and extends between display layer 1062 and support layer 1069. In the embodiment of FIG. 72, touch screen 1060 is utilized to determine the location of a user's touch. The tactile structure of layer 1065 and diaphragm 1064 serves to provide tactile feedback to a user's application of force against layers 1060 and 1062. In the embodiment of FIG. 72, electrical contacts and associated switch structures such as those described above can therefore be eliminated through reliance on touchscreen layer 1060 for determination of touch location.

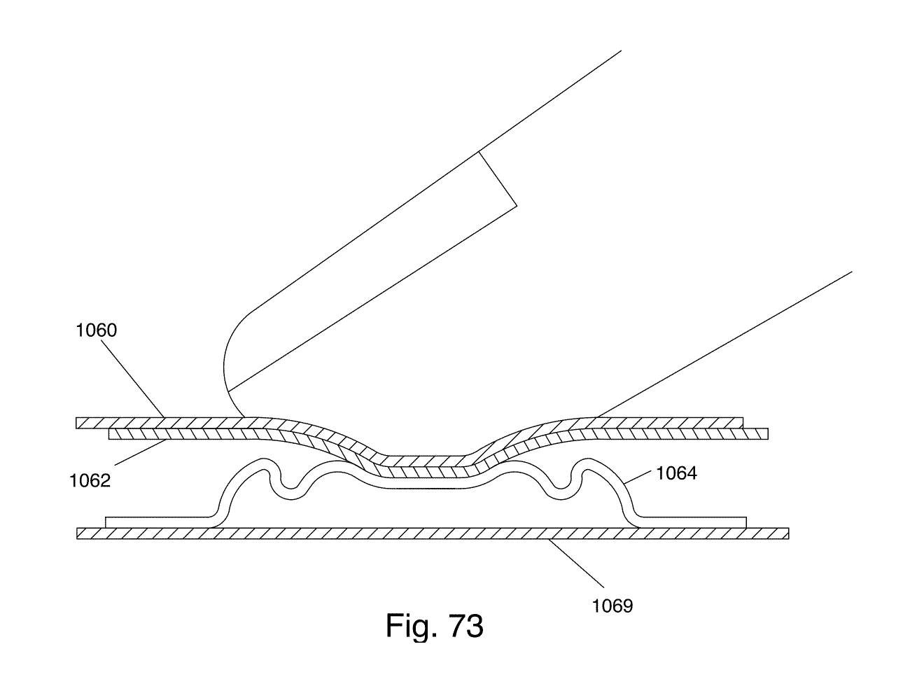

FIG. 73 shows the embodiment of FIG. 72 during application of pressure against touchscreen layer 1060 and display layer 1062 by a user. Diaphragm 1064 collapses downward towards support layer 1069, thereby providing tactile feedback to the user, while signals from touchscreen layer 1060 provide an indication of the location of the user's touch on display 1062.

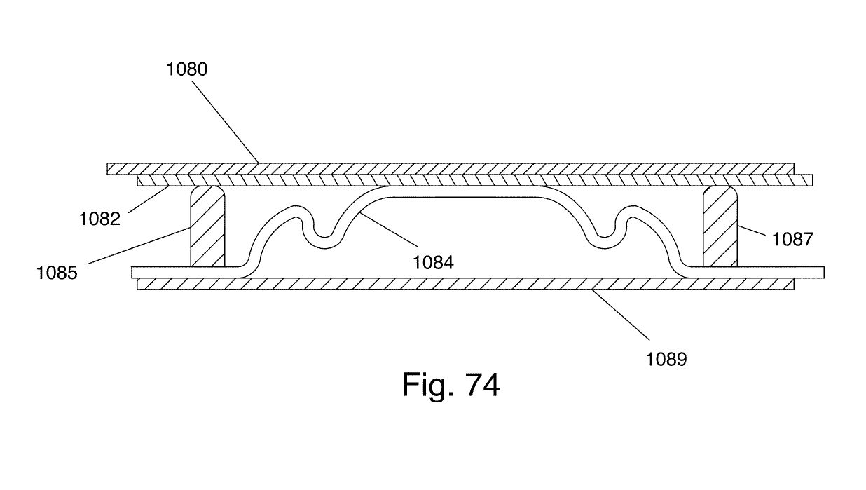

FIG. 74 is a variation on the embodiment of FIG. 72, further implementing a subsurface guidance matrix. Touchscreen layer 1080 and display layer 1082 overlie guidance matrix walls 1085 and 1087. Diaphragm 1084 lies within a guidance matrix cavity formed by walls 1085 and 1087, and overlies support layer 1089.

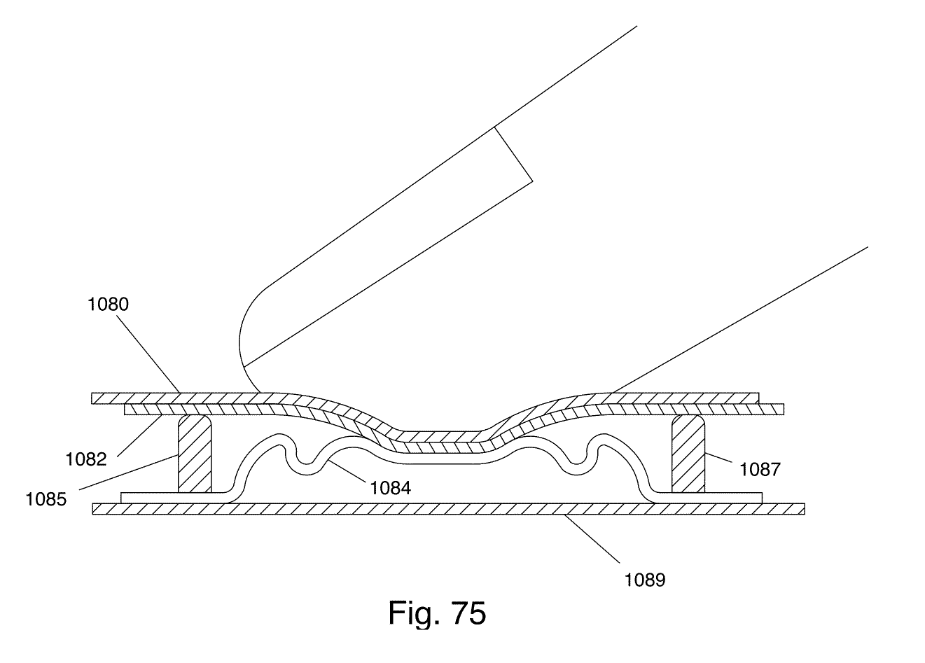

FIG. 75 is a cutaway cross-sectional view of the embodiment of FIG. 74, during application of downward pressure on touchscreen layer 1080 and flexible display screen 1082, at a position within a guidance matrix cavity formed by guidance matrix walls 1085 and 1087. The resistance of diaphragm 1084 as it collapses downwards towards support layer 1089 provides tactile feedback to the user. The location of the user's touch is determined by signals from touchscreen layer 1080. Guidance matrix walls 1085 and 1087 provide guidance, centering and false touch avoidance, while diaphragm 1084 provides force resisting downward deformation of display panel 1082. These effects may provide a user with substantial improvements in accuracy and speed when typing on the mobile device.

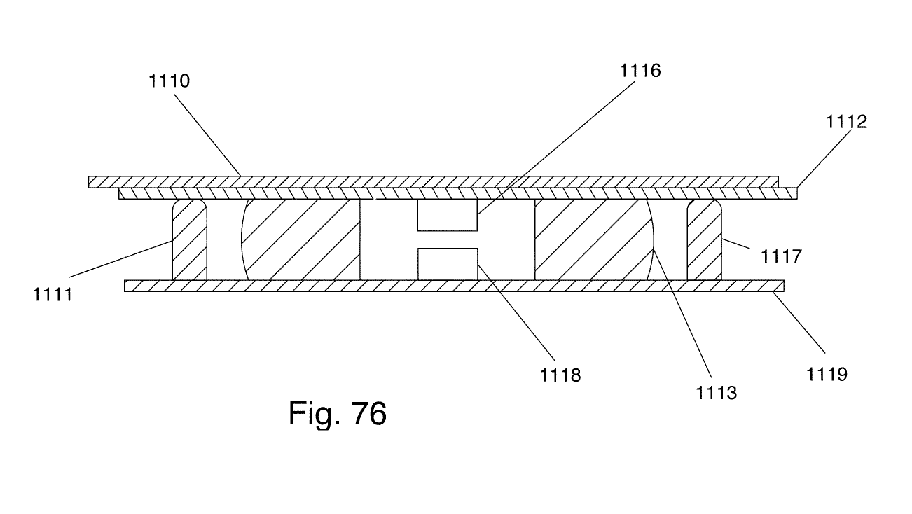

FIG. 76 is a cutaway cross section of another embodiment of a mobile device with subsurface tactile keyboard. Touchscreen 1110 and display layer 1112 overlie guidance matrix walls 1111 and 1117. Support layer 1119 lies beneath guidance matrix walls 1111 and 1117. Elastic body 1113 is provided between screen layer 1112 and support layer 1119, and within a void formed by guidance matrix walls 1111 and 1117. Elastic body 1113 is formed in a hollow barrel-shaped configuration, with a center void in which electrical contacts 1116 and 1118 can be positioned. Upon application of downward force on layers 1110 and 1112, elastic body 1113 can temporarily deform, compressing downwards towards support layer 1119 while expanding slightly outwards towards guidance matrix walls 1111 and 1117, until electrical contacts 1116 and 1118 contact one another, thereby closing a switch and indicating actuation. While elastic body 1113 is formed in a hollow barrel shape, it is contemplated and understood that alternative elastic body forms can be employed, such as cylindrical, conical, truncated conical or others. Depending on the embodiment, guidance matrix including walls 1111 and 1117 can be included or excluded. It may also be desirable in some embodiments to eliminate contacts 1116 and 1118, relying on touchscreen layer 1110 to provide information indicative of the position of a user's touch while employing elastic body 1113 to provide tactile feedback.

While certain embodiments of the invention have been described herein in detail for purposes of clarity and understanding, the foregoing description and Figures merely explain and illustrate the present invention and the present invention is not limited thereto. It will be appreciated that those skilled in the art, having the present disclosure before them, will be able to make modifications and variations to that disclosed herein without departing from the scope of the appended claims.

I claim:

1. A mobile computing device comprising:
a flexible display panel;
a bottom layer generally parallel with, separated from and underlying at least a portion of said flexible display panel;
one or more elastic diaphragms interposed between said flexible display panel and said bottom layer, a first portion of each diaphragm extending towards said bottom layer and a second portion of each diaphragm extending towards said display panel.

2. The mobile computing device of claim 1, in which said one or more elastic diaphragms are formed generally in the shape of convex domes when said flexible display panel rests in an uncompressed state, in which the center of each dome extends towards said flexible display panel and the peripheral portion of each dome extends towards said bottom layer.

3. The mobile computing device of claim 2, in which said one or more elastic diaphragms further contain circumferential folds.

4. The mobile computing device of claim 1, in which said diaphragms are integrally formed from a tactile layer interposed between said flexible display panel and said bottom layer, portions of said tactile layer other than said diaphragms extending proximate said bottom layer.

5. The mobile computing device of claim 1, further comprising:
an upper electrical contact proximate the under side of each of said one or more diaphragms;
a lower electrical contact proximate the top side of said bottom layer, beneath each of said upper electrical contacts, said lower electrical contacts separated from a corresponding one of said upper electrical contacts by an air gap when said corresponding diaphragm rests in an uncompressed state;
whereby the application of downward pressure to said display panel at a position proximate one of said diaphragms can cause said diaphragm to deform downwards towards said bottom layer, such that the upper electrical contact associated with said deformed diaphragm contacts the lower electrical contact underlying said deformed diaphragm to actuate a switch.

6. The mobile computing device of claim 5, in which said diaphragms are integrated with a tactile layer interposed between said flexible display panel and said bottom layer, portions of said tactile layer other than said diaphragms extending proximate said bottom layer; further comprising:
an insulating layer interposed between said tactile layer and said bottom layer, said insulating layer comprising a cavity surrounding each lower electrical contact.

7. The mobile computing device of claim 1, further comprising:
a flexible switch layer between said diaphragms and said bottom layer;
an electrically insulating separation layer interposed between said flexible switch layer and said bottom layer, said separation layer including a cavity beneath each diaphragm;
upper electrical contacts positioned within said separation layer cavities and proximate the underside of said flexible switch layer;
a lower electrical contact corresponding to each upper electrical contact, positioned within said separation layer cavities and proximate the top surface of said bottom layer;
a push rod extending downwards from the underside of each diaphragm towards said upper electrical contacts;
whereby application of downward pressure to said diaphragms forces said push rod to deform downwards said flexible switch layer until a corresponding upper electrical contact makes contact with a corresponding lower electrical contact, thereby actuating a switch.

8. The mobile computing device of claim 1, further comprising a touch sensitive layer adjacent to said display panel.

9. The mobile computing device of claim 1, further comprising a guidance matrix positioned beneath said display panel, said guidance matrix comprising:
guidance matrix walls extending between said display panel and an underlying structure; and
guidance matrix cavities, each of said diaphragms extending into one of said guidance matrix cavities.

10. The mobile computing device of claim 9, further comprising a touch sensitive layer adjacent to said display panel.

11. The mobile computing device of claim 10, in which said touch sensitive layer lies on top of said display panel.

12. The mobile computing device of claim 9, further comprising:
an upper electrical contact proximate the under side of each of said one or more diaphragms;
a lower electrical contact proximate the top side of said bottom layer, beneath each of said upper electrical contacts, said lower electrical contacts separated from a corresponding one of said upper electrical contacts by an air gap when said corresponding diaphragm rests in an uncompressed state;
whereby the application of downward pressure to said display panel at a position proximate one of said diaphragms can cause said diaphragm to deform downwards towards said bottom layer, such that the upper electrical contact associated with said deformed diaphragm contacts the lower electrical contact underlying said deformed diaphragm to actuate a switch.

13. The mobile computing device of claim 9, in which said tablet computer does not include a touchscreen layer proximate said display panel, said tablet computer further comprising:
an upper electrical contact proximate the under side of each of said one or more diaphragms;
a lower electrical contact proximate the top side of said bottom layer, beneath each of said upper electrical contacts, said lower electrical contacts separated from a corresponding one of said upper electrical contacts by an air gap when said corresponding diaphragm rests in an uncompressed state;
whereby the application of downward pressure to said display panel at a position proximate one of said diaphragms can cause said diaphragm to deform downwards towards said bottom layer, such that the upper electrical contact associated with said deformed diaphragm contacts the lower electrical contact underlying said deformed diaphragm to actuate a switch indicative of the location on said display panel at which downward pressure was applied.

14. A mobile computing device comprising:
a flexible display panel;
a bottom layer generally parallel with, separated from and underlying at least a portion of said flexible display panel;
one or more elastic bodies interposed between said flexible display panel and said bottom layer, said elastic bodies providing resistive force in response to the application of downward pressure on a portion of said flexible display panel proximate one of said elastic bodies.

15. The mobile computing device of claim 15, further comprising a touchscreen layer proximate said flexible display panel.

16. The mobile computing device of claim 14, further comprising:
one or more upper electrical contacts proximate the under side of said display panel;
a lower electrical contact proximate the top side of said bottom layer, beneath each of said upper electrical contacts, said lower electrical contacts separated from the corresponding upper electrical contacts by an air gap when downward force is not applied to a portion of said flexible display panel proximate said upper electrical contact;
whereby the application of downward pressure to said display panel at a position proximate one of said upper electrical contacts can cause said display panel to deform downwards towards said bottom layer, and elastically deform at least one of said elastic bodies, such that the proximate upper electrical contact makes contact with the lower electrical contact underlying it to actuate a switch.

17. The mobile computing device of claim 16, in which each of said elastic bodies contains a cavity within its center extending from the top surface of said elastic body to the bottom surface of said elastic body, and wherein said upper electrical contacts and said lower electrical contacts are disposed within a cavity of one of said elastic bodies.

18. The mobile computing device of claim 17, in which said elastic body is barrel shaped.

19. The mobile computing device of claim 17, further comprising a touchscreen layer adjacent to said display panel.

20. The mobile computing device of claim 14, further comprising a guidance matrix positioned beneath said display panel, said guidance matrix comprising:
guidance matrix walls extending between said display panel and said bottom layer; and
guidance matrix cavities, each of said elastic bodies being disposed within one of said guidance matrix cavities.

21. The mobile computing device of claim 16, further comprising a guidance matrix positioned beneath said display panel, said guidance matrix comprising:
guidance matrix walls extending between said display panel and said bottom layer; and
guidance matrix cavities, each of said elastic bodies being disposed within one of said guidance matrix cavities.

22. The mobile computing device of claim 1, in which said mobile computing device is a tablet computer.

23. The mobile computing device of claim 1, in which said mobile computing device is a cellular telephone.

24. An electronic display comprising:
a flexible display panel;
a rigid bottom layer generally parallel with, separated from and underlying at least a portion of said flexible display panel;
one or more elastic diaphragms interposed between said flexible display panel and said bottom layer, a first portion of each diaphragm extending towards said bottom layer and a second portion of each diaphragm extending towards said display panel.

25. The electronic display of claim 24, in which said elastic diaphragms are formed in the shape of convex domes with one or more circumferential folds, the center portion of each dome extending towards said display panel and the peripheral portion of each dome extending towards said bottom layer.

26. The electronic display of claim 24, further comprising a touch sensitive layer adjacent to said flexible display panel.

27. The electronic display of claim 24, further comprising:
an upper electrical contact proximate the under side of each of said one or more diaphragms;
a lower electrical contact proximate the top side of said bottom layer, beneath each of said upper electrical contacts, said lower electrical contacts separated from a corresponding one of said upper electrical contacts by an air gap when said corresponding diaphragm rests in an uncompressed state;
whereby the application of downward pressure to said display panel at a position proximate one of said diaphragms causes said diaphragm to deform downwards towards said bottom layer, such that the upper electrical contact associated with said deformed diaphragm contacts the lower electrical contact underlying said deformed diaphragm to actuate a switch.

28. The electronic display of claim 27, further comprising a guidance matrix positioned beneath said display panel, said guidance matrix comprising:
guidance matrix walls extending between said display panel and an underlying structure; and
guidance matrix cavities, each of said diaphragms extending into one of said guidance matrix cavities.
